(19) United States
(12) Patent Application Publication
(10) Pub. No.: US 2010/0252177 A1
(43) Pub. Date: Oct. 7, 2010

(54) ADHESIVE MICROSTRUCTURES

(75) Inventors: Jeffrey Paul Sargent, Bristol (GB); Sajad Haq, Bristol (GB); Tracey Ann Hawke, Bristol (GB); Joseph Maurice Davies, Bristol (GB)

Correspondence Address: PILLSBURY WINTHROP SHAW PITTMAN, LLP, P.O. BOX 10500, MCLEAN, VA, 22102, US

(73) Assignee: BAE SYSTEMS plc, London (GB)

(21) Appl. No.: 12/302,379

(22) PCT Filed: Oct. 27, 2008
(86) PCT No.: PCT/GB2008/003619

§ 371 Date: Aug. 11, 2009

(30) Foreign Application Priority Data
Oct. 26, 2007 (EP) 07254250.9
Oct. 26, 2007 (GB) 0721044.6

(51) Int. Cl. B32B 38/10; B32B 3/30; B32B 27/00; B29C 39/38; B29C 33/40; B29C 33/38; C08G 77/04; C08G 18/00

(52) U.S. Cl. 156/152; 428/156; 428/446; 264/331.11; 264/219; 528/10; 528/85

(57) ABSTRACT

Improved fabricated adhesive microstructures and methods of fabricating adhesive microstructures incorporating deformable materials are provided. The fabricated adhesive microstructures exhibit significantly improved adhesion strengths at least at smooth surfaces such as glass, as compared to known fabricated adhesive microstructures. The adhesion strengths of fabricated microstructures of the invention for a range of smooth glass contact surfaces may be in the range of between about 125 kPa and 220 kPa in air at one atmosphere pressure and in the range of between about 25 kPa and 120 kPa in vacuum. Synthetic elastomers are used in the invention. A method of fabricating new adhesive microstructures having multiple levels of compliance with a surface has been proposed. Methods of fabricating new double-sided adhesive microstructures via moulding have further been proposed.

### FIELD OF THE INVENTION

This invention relates to fabricated adhesive microstructures, and to methods of their fabrication.

### BACKGROUND OF THE INVENTION

There has been significant interest in the fabrication of adhesive structures. Adhesive mechanisms in nature have been studied for a long time, but have not been fully understood or exploited. For example, geckos are recognised to be exceptional in their ability to climb up smooth vertical surfaces, and this has prompted several groups to attempt to fabricate adhesive structures which mimic the adhesive pads on the feet of geckos. Known proposed applications for exploitation of the remarkable adhesive properties of the gecko foot include areas where a dry, re-attachable adhesive bond would be of benefit, for example in high performance climbing robots (see M Sitti's paper on “High aspect ratio polymer micro/nanostructure manufacturing using nanoembossing, nanomoulding and directed self-assembly”, IEEE/ASME Advanced Mechatronic Conference, Kobe, Japan, July 2003). It has been suggested that the ability of geckos to climb and cling to surfaces is due to an intricate branching fibre structure comprising many micro/nanofibres which terminate in a pad or setal area which is in intimate contact with the surface (see for example M Sitti and R S Fearing's paper on “Synthetic gecko foot-hair micro/nanostructures for future wall-climbing robots”, JAST, 18, 1055, 2003). It is believed that this fibre structure confers compliance on a range of length scales sufficient to accommodate rough surfaces (see M Sitti and R S Fearing's above mentioned paper), and it is believed that the setal pad area achieves adhesion via intermolecular forces such as Van der Waals' forces (see for example London's seminal paper on “The general theory of molecular forces”, Transac. Faraday Soc. 1937, 33, 8-26 and K Autumn et al's paper on “Evidence for Van der Waals' adhesion in gecko setae”, PNAS, Sep. 17, 2002, Vol. 99, no. 19, 12252-12256).

Several groups have reported on the successful fabrication of synthetic adhesive microstructures. This includes, for example, electron-beam lithography of polyimide (see A K Geim et al's paper on “Microfabricated adhesive mimicking gecko foot-hair”, Nature Materials, Vol. 2, July 2003, 461), nanomoulding using silicon rubber (see N J Glassmaker et al's paper on “Design of biomimetic fibrillar interfaces: 1. Making Contact”, J. R. Soc. Lond. Interface 2004), polyimide (see A K Geim et al's above mentioned paper) and polyurethane (see D Campolo et al's paper on “Fabrication of gecko foot-hair like nanostructures and adhesion to random rough surfaces”, IEEE Nano. August 2003). Average bond strengths with glass substrates of 30 kPa have been reported by Geim et al (see their above mentioned paper) for 1 cm² patches of microfabricated polyimide fibres of length of 2 μm, diameter 0.5 μm with separation between fibres of 1.6 μm. According to Geim et al's paper, these values compare with estimated values for the adhesive bond strength of gecko feet hair of approximately 100 kPa. It is to be also noted that Kesel et al have reported an adhesion strength of 224 kPa for the jumping spider (see Kesel et al's paper. “The J of Exp. Biol.”, 2003, 206, 2733).

### OBJECTS AND SUMMARY OF THE INVENTION

It is an object of the present invention to provide adhesive microstructures having significantly improved adhesion strengths at least at one surface as compared to known fabricated adhesive microstructures.

It is a further object of the present invention to provide methods of fabricating such adhesive microstructures. A yet further object of the present invention is to provide adhesive microstructures which provide good immediate adhesion on a variety of surfaces. Another object of the invention is to provide a method of producing relatively large areas of the adhesive material. Another object of the invention is to provide a re-useable adhesive microstructure.

In broad terms, the present invention resides in the concept of using the properties of deformable materials in fabricated adhesive microstructures to provide significantly high adhesion strengths at one or more surfaces, and in the methods of fabricating adhesive microstructures incorporating deformable materials.

Accordingly, in one aspect, this invention provides a fabricated adhesive microstructure comprising a deformable material which, in use, deforms to provide an adhesion strength at a substantially smooth glass surface of at least 120 kPa in air at one atmosphere pressure and at least 10 kPa less (preferably at least 20 kPa less, or more preferably at least 50 kPa less) adhesion strength in vacuum than that at one atmosphere pressure.

The term “adhesion strength” is used in the present specification and claims to mean tensile pull-off adhesion strength. Furthermore, as will be described hereinafter, all values of “adhesion strength” in this specification (except where stated otherwise) are to be understood to correspond to tensile pull-off adhesion strengths which were measured by use of a purpose-built beam balance at The Advanced Technology Centre, Filton, BAE SYSTEMS.

As will be described hereinafter, we have carried out tests and experiments using smooth glass microscope slides. Such slides are commercially available and can be purchased from a number of suppliers including Menzel GmbH (see their website: www.menzel.de).

The adhesion force measurements of our fabricated microstructures made in vacuum will be described hereinafter. The term “in vacuum” (as used in the present specification and claims) is to be understood in this context.

We do not understand fully the role which the deformable material to be used plays in the adhesion of the fabricated microstructures of the invention. We suggest, however, without intending to limit the scope of the invention in any way, that the reason for the improved adhesion strengths of our adhesive microstructures is the significant atmospheric “suction cup” force contribution which the deformable material provides in atmosphere, in addition to the Van der Waals' contribution. In support of this, as will be described hereinafter, we have surprisingly found that adhesion force measurements of our fabricated adhesive microstructures alternately in vacuum and in air indicate there to be a significant atmospheric contribution of up to about 100 kPa in air for a range of smooth glass contact surfaces. Advantageously, we have further found that the adhesion strength of fabricated microstructures of the invention for a range of smooth glass contact surfaces may be in the range of between about 125 kPa and 220 kPa in air at one atmosphere pressure and in the range of between about 25 kPa and 120 kPa in vacuum.

Preferably, the deformable material is an elastomer. Conveniently, synthetic elastomers are used. Conveniently, the elastomer is a silicone polymer. The polymer material may comprise polydimethylsiloxane (PDMS) which is known to contain units of the formula

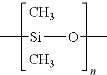

where n is the number of monomer units in the polymer molecules.
Optionally, the PDMS is Sylgard 170, Sylgard 184 or Sylgard 186. It is to be noted that the silicone elastomers Sylgard 170, Sylgard 184 and Sylgard 186 are commercially available and can be purchased from a number of suppliers including Dow Corning Corporation (see the Dow Corning website).

Optionally, the elastomer is a polyurethane. Conveniently, the polyurethane may comprise monothane A30. It is to be noted that monothane A30 is commercially available from Chemical Innovations Limited of 217, Walton Summit Road, Walton Summit Centre, Preston, Lancashire, United Kingdom (see website www.polycil.co.uk).

In one embodiment, a first level of hierarchical compliance with the surface is provided in the structure by means of formation of a first number of protrusions on a first set of stalks, the protrusions and the stalks being formed of the deformable material and the protrusions being arranged to provide the adhesive strength at the surface. The stalk lengths may be in the range of between about 20 μm and 100 μm, and the protrusions may have generally mushroom-shaped head formations with head diameters in the range of between about 10 μm and 40 μm and thicknesses in the range of between about 1 μm and 3 μm. Advantageously, we have found that such structures can provide a generally uniform stress distribution at the interface between the stalks with mushroom-shaped head formations and the surface. Further, we have found that such structures have a level of compliance which permits improved contact and adhesion to a range of surfaces which may be rough on a variety of scales. Advantageously, such structures can be fabricated via different routes using moulding. Conveniently, these structures have been found to be sufficiently robust as to permit multiple reattachment with adequate adhesion to a number of surfaces. In addition, such structures have been found to work in the presence of fluids, for example water, and are amenable to cleaning procedures when inevitably dirt and contamination arise.

In another embodiment, one or more additional levels of hierarchical compliance with the surface are provided in the structure by combination of the above described set of stalks and protrusions with one or more additional sets of stalks and additional numbers of protrusions, the additional stalks and the additional protrusions being formed of the above described deformable material. Because such structures have at least one additional scale of compliance, it is possible to achieve significantly improved adhesion and contact of the structures to a range of surfaces. Advantageously, such structures can be fabricated using a moulding technique.

Optionally, a double-sided adhesive microstructure may be provided by providing the above described deformable material as a first layer on one surface of the structure and as a second layer on an opposing surface of the structure. Such a structure can be conveniently fabricated using a moulding process.

It is to be appreciated that the above described fabricated adhesive microstructures of the invention enjoy various benefits over currently available glues and adhesives. For example, our structures can be (a) reapplied effectively to various surfaces many times if desired, (b) applied to surfaces without relying on the use of messy glues, (c) used without requiring any special surface preparation, and (d) applied easily and rapidly. Additionally, our structures can stick to a wide range of surfaces. Furthermore, our structures are inert and biocompatible.

In another aspect, this invention provides a method of fabricating an adhesive microstructure comprising the steps of (i) providing a mould structure; (ii) introducing a curable liquid polymer into the mould structure; (iii) curing the polymer in the structure; and thereafter (iv) separating the polymer from the mould structure to form the microstructure.

In one example of the method, the mould structure may be provided by forming first and second arrays of cavities at opposing surfaces of a base material, and forming an array of channels which extend through the base material at predetermined regions between said first and second arrays of cavities. The cavities of the first array may have a significantly different size from the cavities of the second array. The cavities of the first array may have diameters of approximately 40 μm and the cavities of the second array may have diameters of approximately 20 μm. Optionally, in this example, the method may include a step of providing a support made of pyrex or SD2 glass, and bonding the support to the surface of the base material at which the 40 μm diameter cavities are formed.

The base material is conveniently formed of silicon. As will be described hereinafter, we have found that the above described structures having a first level of compliance with the surface can be fabricated according to this example of the method.

In another example of the method, the mould structure may be provided by forming an array of channels through a base material which is supported on an etch-stop backing material. Conveniently, the base material is formed of silicon and the etch-stop backing material is formed of silicon oxide. As will be described hereinafter, we have found that the above described structures having a first level of compliance with the surface can be fabricated according to this example of the method.

In yet another example of the method, the mould structure may be provided by the following steps: (a) forming a first array of cavities at a surface of a first base material; (b) forming an array of channels through a second base material which is supported on an etch-stop backing material; (c) attaching the first base material to the second base material at a surface such as to provide an alignment between the cavities in the first base material and the channels in the second base material at said surface; and (d) forming a second array of cavities at an exterior exposed surface of the attached base material, and forming an array of channels therefrom which extend through the base material at predetermined regions between said second array of cavities and said surface at which the cavities in the first base material and the channels in the second base material are aligned. Conveniently, the first base material is attached to the second base material using a bonding process. Alternatively, the first base material is attached to the second base material by clipping the first and second base materials together. Optionally, the first and base materials are formed of silicon, and the etch-stop backing material is formed of silicon oxide. The cavities of the first array may have a significantly different size from the cavities of the second array. The cavities of the first array may have diameters of approximately 40 μm and the cavities of the second array may have diameters in the range of between about 7 μm and 20 μm. As will be described hereinafter, we have found that the above described structures having one or more additional levels of hierarchical compliance with the surface can be fabricated according to this example of the method.

In each of the above examples of the method, each said array of cavities and each said array of channels are formed by applying lithography and etching techniques through the use of masks.

Optionally, the curing step of the method may comprise applying heat to the polymer in the structure at elevated temperature for a predetermined duration. The elevated temperature may be approximately 65° C. and the predetermined duration may be approximately 4 hours. Preferably, in the method the liquid polymer cures to an elastomer. The liquid polymer may comprise monothane A30. Alternatively, the liquid polymer may comprise polydimethylsiloxane (PDMS) which is known to contain units of the formula

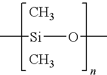

### Optionally, the PDMS may be Sylgard 170, Sylgard 184 or Sylgard 186.

Optionally, in the method the liquid polymer is introduced into the mould structure by (a) distributing the polymer across the channels of the structure; (b) placing the structure inside a chamber in vacuum and controllably extracting air from the channels; (c) restoring the chamber to atmospheric pressure; and thereafter (d) infiltrating the polymer into the channels. The liquid polymer introduced in this way may comprise monothane A30. Alternatively, the liquid polymer which is introduced may comprise PDMS (Sylgard 170, Sylgard 184 or Sylgard 186).

The present invention extends to a method of fabricating a double-sided adhesive microstructure comprising the steps of (i) forming a first adhesive microstructure according to the above described method; (ii) partially forming a second adhesive microstructure according to steps (i) and (ii) of the above described method; (iii) pressing the formed first microstructure onto the partially formed second microstructure whilst the polymer, PDMS for example, in the mould structure is in liquid condition; (iv) curing the pressed structure of (iii); and thereafter (v) separating the cured structure of (iv) from the mould structure so as to form the double-sided microstructure. Preferably, in this method the curing step comprises applying heat to the pressed structure at elevated temperature for a predetermined duration. Optionally, heat may be applied to the pressed structure inside an oven at approximately 150° C. for approximately 10 minutes.

The present invention further extends to a method of fabricating a double-sided adhesive microstructure comprising the steps of (i) defining a structure with a cavity region by juxtaposing first and second mould structures; (ii) introducing liquid polymer into the cavity region and subjecting the defined structure of (i) to vacuum conditions thereby to cause filling of the cavity region by said polymer; (iii) curing the filled structure of (H); and (iv) removing the first and second mould structures to leave a formation of the double-sided microstructure. Preferably, the first and second mould structures are in juxtaposed spatial alignment by providing a nylon spacer between said first and second mould structures.

Optionally, the first and second mould structures are removed in aforesaid step (iv) by mechanical release.

Alternatively, the first and second mould structures are removed in aforesaid step (iv) using a chemical etching process.

Conveniently, in this method, the aforesaid curing step (iii) may comprise applying heat to the filled structure at elevated temperature for a predetermined duration. The heat may be applied to the filled structure inside an oven at approximately 150° C. for approximately 10 minutes.

Optionally, the first and second mould structures are formed of silicon.

Alternatively, the first and second mould structures are formed of polyimide.

The polymer used may comprise PDMS (Sylgard 184 for example).

The present invention further extends to a method of removably attaching a fabricated adhesive microstructure to a surface comprising the steps of (i) applying the above described structure to the surface at a first location; and (ii) removing the structure for re-application to the surface at the same location or at a different location.

Optionally, the aforesaid removing step (ii) comprises a peeling action.

Advantageously, the aforesaid removing step (ii) may be effected or assisted by application of a chemical agent at the contact location between the surface and the microstructure. The chemical agent may comprise Skydrol liquid.

The present invention further extends to a fabricated adhesive microstructure comprising an elastomer which, in use, deforms to provide an adhesion strength at a substantially smooth glass surface of at least 120 kPa in air at one atmosphere pressure and at least 10 kPa less (preferably at least 20 kPa less, or more preferably at least 50 kPa less) adhesion strength in vacuum than that at one atmosphere pressure.

It is to be appreciated that the present invention has utility for many applications including (i.e. not limited to) the following: automated inspection robots, rapid reattachment of panels with no special surface preparation, for example in rapid field repair, attachment of access panels, “Spiderman gloves” etc.

The above and further features of the invention are set forth in the appended claims and will be explained in the following by reference to various exemplary embodiments and the specific Examples and Experiment which are illustrated in the accompanying drawings in which:

### BRIEF DESCRIPTION OF THE DRAWINGS

FIG. 1 is a schematic illustration of the steps of a method of fabrication of a new adhesive microstructure according to a first embodiment of the invention;

FIGS. 2 (a), (b) and (c) are schematic illustrations of the mask patterns used in the method of FIG. 1 (note the mask patterns define 20 μm diameter stalks and 40 μm diameter heads, and also show the disposition of combined concentric heads and stalks. Note also that the white areas define the masked blanking regions);

Table 1 is a table of etch parameters and processing conditions used in the method of FIG. 1;

FIG. 3 is an image of an adhesive microstructure produced by the method of FIG. 1;

FIG. 4 is a schematic illustration of the steps of another method of fabrication of a new adhesive microstructure according to another embodiment of the invention;

FIG. 4B is an exploded schematic view (not to scale) of a new adhesive microstructure produced by the method of FIG. 4;

FIG. 5 is an image of another adhesive microstructure produced by another method according to another embodiment of the invention;

FIG. 6 is a schematic illustration of a mask pattern used in the method which produces the structure shown in the image of FIG. 5;

FIG. 7 is an exploded schematic view (in cross-section) of a channel formation (dimensions shown) in a new mould structure obtained using the method of FIG. 4;

Table 2 is a table of properties of the moulding polymers used in the Examples of the invention;

Table 3 is a table of results of adhesive measurements for a number of structures produced according to the invention;

FIG. 8 is a perspective view of a purpose-built beam balance used to measure pull-off adhesion strengths of a number of structures which are produced according to the invention;

FIG. 9 is a view (in cross-section) of the specimen assembly as mounted on the balance of FIG. 8;

FIG. 10 is a graph showing the results of successive loads measured for one structure of the invention on different surfaces;

FIG. 11 is a photomicrograph of the contact area for one structure of the invention on a glass surface using interferometry;

FIG. 12 is an image showing how hairs detached from one structure of the invention, remain in contact with a glass slide after adhesion testing;

FIG. 13 is another image showing the contact of one structure of the invention with a rough CFRP surface (note the small scale roughness with some conformation of the mushroom-head to the surface, and the larger scale roughness with the mushroom-head on the right of the image clear of the surface);

FIG. 14 is another image showing the contact of one structure of the invention with a glossy painted surface;

FIG. 15 is an exploded schematic view (in cross section) of a channel formation (dimensions shown) in a mould structure obtained in an Example using the method of FIG. 1;

FIG. 16 is a graph showing the results of successive loads measured for another structure of the invention on difference surfaces;

FIG. 17 is an image of a glass slide after detachment of a structure of the invention from the glass (note the dark rings showing remnants of the mushroom-heads and the detached hairs (dark circles));

FIG. 18 is an SEM image of another structure of the invention on a painted CFRP surface;

FIGS. 19(a) and (b) are further SEM images of another structure of the invention on a painted CFRP surface (note detachment of polymer from mushroom-head);

FIG. 20(a) is a schematic plan view of a mould structure obtained using the method of step 2 in FIG. 4 (corresponding mask pattern similar to that of FIG. 6), and FIG. 20(b) is an exploded schematic view (in cross-section) of a channel formation (dimensions shown) in this structure;

FIG. 21 are SEM images of another structure of the invention produced by using the method of step 2 in FIG. 4;

FIG. 22 is an image showing detached hairs remaining on glass for another structure of the invention after adhesion testing;

FIG. 23 is an image showing a superhydrophobic fabricated adhesive structure;

Table 4 is a table of pull-off loads (adhesion strengths) as measured by different workers on different synthetic and real gecko materials;

FIGS. 24(a), (b) and (c) are images of another structure of the invention after (a) contamination with hairs, dust and dirt; (b) after cleaning using water droplets; and (c) after a water jet clean;

FIG. 25 is an image of another structure of the invention with a small water droplet on the surface capturing a hair;

FIG. 26 is a graph showing the results of successive loads measured for another structure of the invention before and after cleaning;

FIG. 27 is an image of another structure of the invention immersed in Skydrol and in contact with a glass slide;

FIG. 28 is a schematic illustration of the steps of a method of fabrication of a new double-sided adhesive microstructure according to another Example;

FIGS. 29(a) and (b) are images of a new double-sided adhesive microstructure produced by another method;

FIG. 30 is a schematic illustration of the steps of another method of fabrication of a new double-sided adhesive microstructure;

FIG. 31(a) and (b) are images of another new hierarchical structure having multiple levels of compliance;

FIG. 32 is an image of another new hierarchical structure having multiple levels of compliance; and

FIG. 33 is a schematic illustration of the steps of another method of fabrication of a new adhesive microstructure according to another embodiment of the invention.

### DETAILED DESCRIPTION OF EXEMPLARY EMBODIMENTS AND EXAMPLES

### Method 1 (First Embodiment)

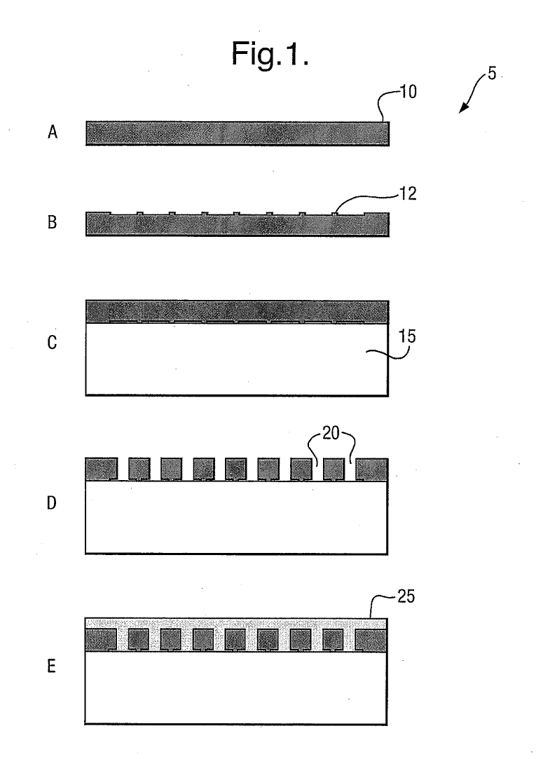

Referring first to FIG. 1, there is schematically shown therein the various steps (A to E) of a method 5 of fabrication of new mushroom-headed adhesive microstructures in accordance with a first embodiment of the invention.

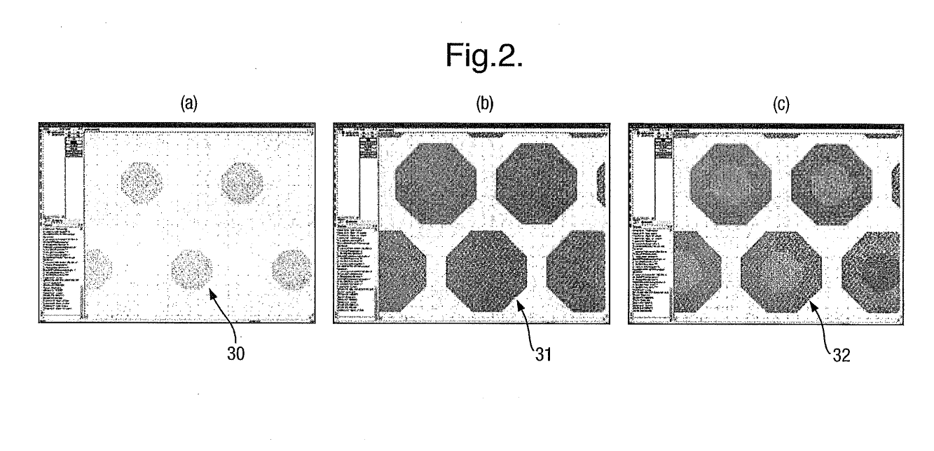

Two masks (not shown in FIG. 1) were drawn, one with blanking regions defining stalks of the mushroom-headed structure (in the first instance, 20 μm diameter features were chosen) and the other defining blanking regions of the mushroom-heads (40 μm diameter features chosen). These were patterned in hexagonal arrays to maximise packing density, and had common centres. Both of the masks were patterned over their entire area in order to define approximately 1.2 million hair structures. An example of parts of the mask patterns 30, 31, 32 with these chosen diameters are shown in FIGS. 2a, b and c. A silicon wafer 10 with a thickness which defined the stalk length was obtained (Step A), and the 40 μm mask was then used to pattern one side of the silicon wafer with resist. The 40 μm diameter features were etched 12 (Step B) to a depth which was determined by the thickness of the mushroom head chosen to give the necessary additional compliance (approximately 3 μm and 1 μm depth used here).

As will be readily understood by the man skilled in the art of lithography and etching techniques, etch parameters and procedures were used in this embodiment as given in Table 1 below.

TABLE 1
Processing Conditions

The initial 1 μm etch was done in a Reactive Ion Etcher (RIE), with
parameters of:
54 milliTorr (mT)
100 standard cubic centimetres per second (sccms) of sulphur
hexafluoride (SF₆)
250 W
5 mins
The through-wafer etch was done on a commercially available
Surface Technology Systems (see website: www.stsystems.com)
machine, a Deep Reactive Ion Etcher (DRIE), with parameters of:
Etch phase:
7 secs
27 millitorr (mT)
480 sccms Sulphur hexafluoride (SF₆)
2200 W Coil
30 W Platen
Passivation Phase:
2 secs
11 milliTorr (mT)
200 sccms octafluorocyclobutane (C₄F₈)
1300 W Coil
20 W Platen
Total Time: 25 mins

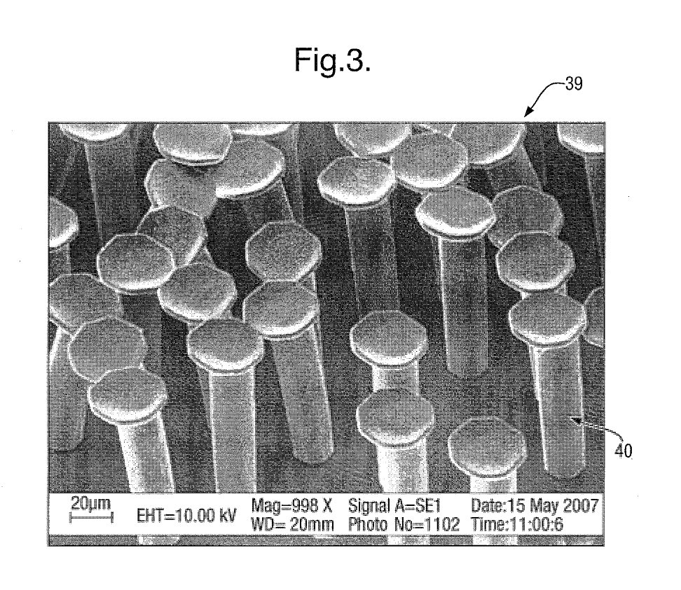

The wafer was then anodically bonded to a Pyrex (or SD2 glass) substrate 15 (Step C), positioning the 40 μm cavities at the glass/silicon interface. The purpose of the substrate was to provide mechanical support for the wafer and give a flat surface for moulding the mushroom-shaped structures. The 20 μm mask was then used to pattern the top side of the wafer, which was then etched using the same procedures specified above to produce 20 μm diameter holes 20 through the entire thickness of the wafer, meeting the 40 μm cavities with a common axis (Step D). The mould was coated in fluorocarbon release agent, and a polymer PDMS solution 25 was then spun onto the mould (Step E). This was then cured for about 10 minutes at 150° C. The resulting casting comprising stalks and mushroom heads was then pulled out through the mould in a single peeling process. This produced microstructures 40 like that shown in the image 39 of FIG. 3 for a mushroom head thickness of 3 μm, stalk length of 100 μm, and stalk diameter of 20 μm.

Conveniently, it is to be noted that the resulting mould made by using this method was suitable for making multiple casting operations.

It is to be further appreciated that the above described method 1 can be suitably modified of provide alternative new hierarchical structures having multiple levels of compliance.

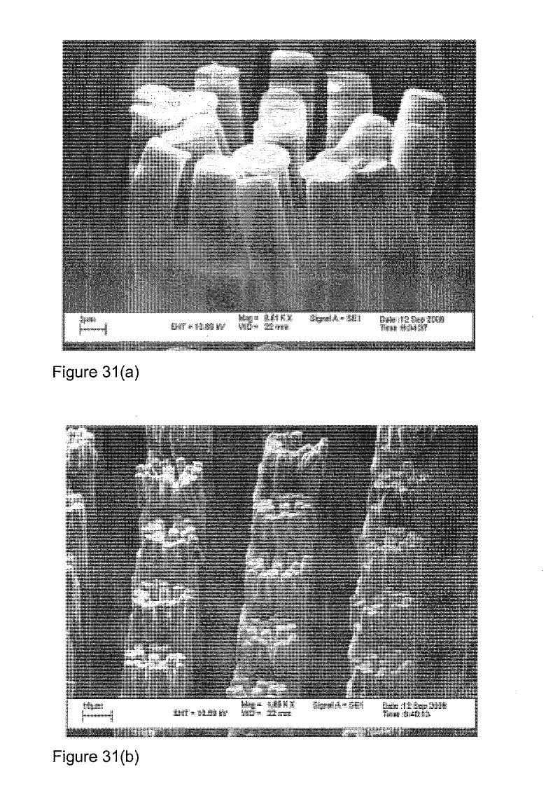

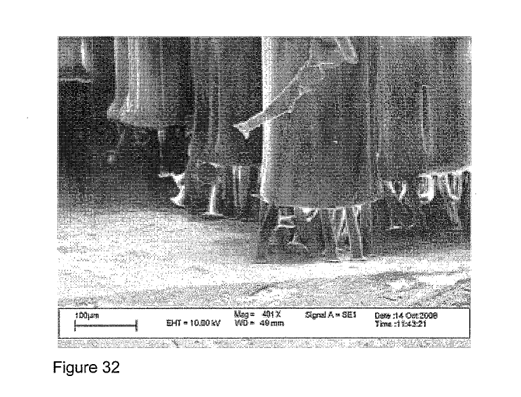

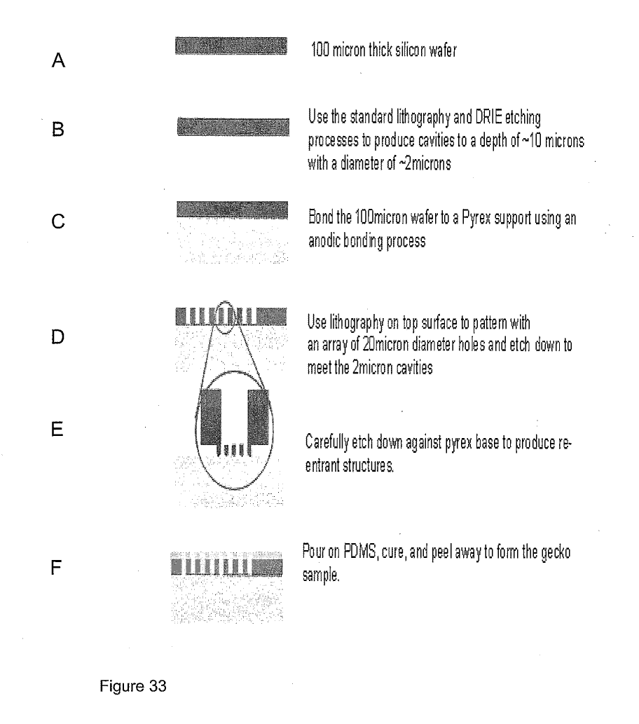

In one possible modification example shown in FIG. 33, an etching step E′ is incorporated into the method 5′, the steps A′ to D′ and F′ generally corresponding to the steps A to E of method 1. The processing conditions are based on the processing conditions of Table 1. FIG. 33 employs like reference numerals as are employed in FIG. 1 for same/like parts. As shown, the additional new etch down step E′ is effected at the silicon 10′/substrate 15′ interface to provide increased etching of the side walls, which in turn results in the production of re-entrant mushroom head structures. By switching to a low frequency (380 kHz) plasma etching step (see Morioka H, Matsunaga D and Yagi H 1998 Suppression of notching by lowering the bias frequency in electron cyclotron resonance plasma with a divergent magnetic field J. Vac. Sci. Technol. A 16 1588-92) just before the substrate 15′ is exposed to the etch, the inventors have found that the problem of “footing” can be minimised. (“Footing” as applied to mushroom-type structures is described in the paper by Hwang, Gyeong, Giapis, and Konstantinos: “On the origin of the notching effect during etching in uniform high density plasmas” (1997), Journal of Vacuum of Science and Technology B, 15(1) pp 70-87). Note that the different parameters/dimensions specified on FIG. 33 are used in this particular example to provide 2 μm mushroom-shaped hairs on 100 μm long 20 μm diameter stalks. Images 300, 305 of the resulting structure 301 at two different levels of magnification are shown in FIGS. 31(a) and (b). As shown, large areas of the material covering the whole mould were produced. The parameters/dimensions specified on the Figure can be varied if desired, to produce other new mushroom head structures of different shapes/sizes.

In another possible modification example, the steps A to D of the above described method 1 are performed to provide a structure with cavities on to which is bonded a silicon wafer with holes formed through its entire thickness. The two wafers are thus attached to each other at a surface in such a way that the formed hole/cavities in the wafers are made to coincide at the surface. Bonding is effected by forming a eutectic between the wafers, or by means of adhesive bonding. PDMS polymer is then introduced into the mould in exactly the same way and under then same conditions as described before in method 1 (see step E, FIG. 1) to form a new mushroom-shaped hierarchical structure with stalks which is then pulled out through the mould. An example of the resulting structure 311 (40 μm diameter mushroom headed stalk, 100 μm long 20 μm diameter on top of 200 μm diameter 1 mm long stalks), using a 1 mm thick silicon wafer which had been previously etched through the entire thickness with 200 μm diameter holes, is shown in the image 310 of FIG. 32. The structure 311 is shown to be in contact with a matt painted aluminium surface 312.

Because the structure 311 provides an additional level of elastic compliance, it is envisaged that this kind of structure can provide improved contact with a surface (for example, a matt painted CFRP surface) having a large scale of roughness.

In yet another possible modification example, the steps A′ to E′ of the above described method of FIG. 33 can be performed to provide a structure with cavities on to which is bonded a silicon wafer with holes formed through its entire thickness (for example, a 1 mm thick silicon wafer could be used with 200 μm diameter holes etched through its entire thickness). The two wafers are thus attached to each other at a surface in such a way that the formed holes/cavities in the wafers are made to coincide at the surface. Bonding is effected by forming a eutectic between the wafers, or by means of adhesive bonding. PDMS polymer is then introduced into the mould in the same way and under the same conditions as described before in method 1 to form another new mushroom-shaped hierarchical structure with stalks which is then pulled out through the mould. The resulting structure with a further level of elastic compliance (not shown) is envisaged to provide improved contact with a surface having a large scale of roughness.

### Method 2 (Second Embodiment)

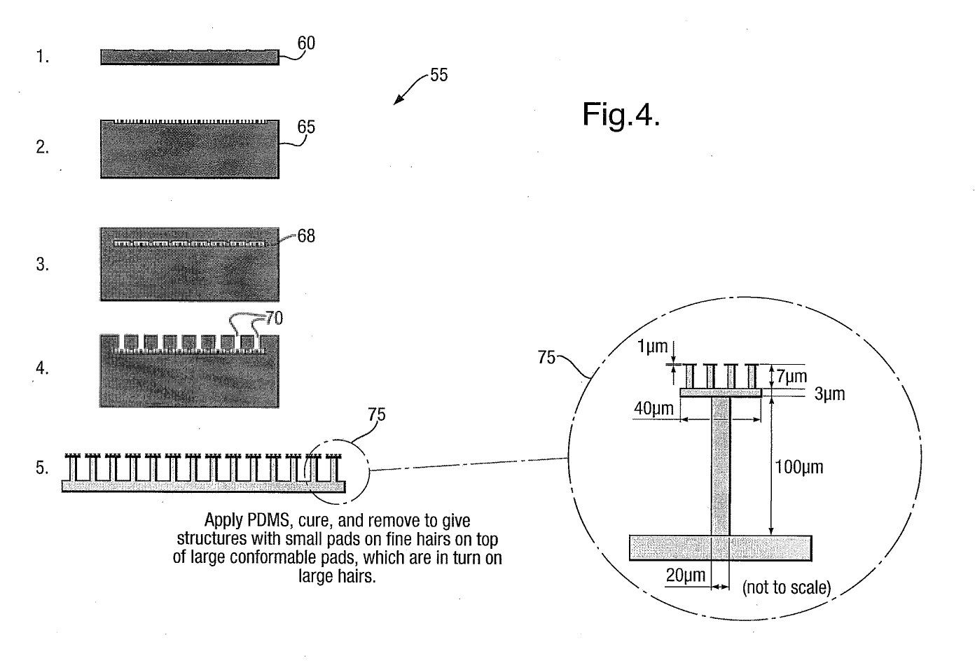

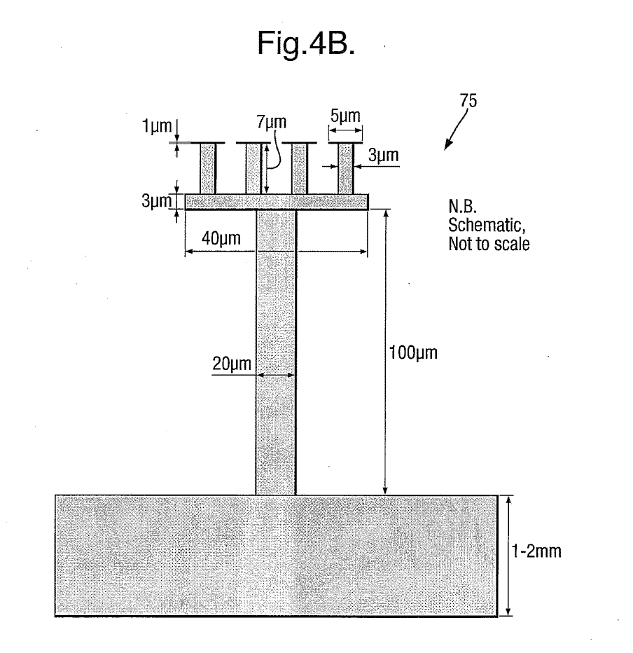

Referring next to one of the steps (step 2.) of FIG. 4, there is schematically shown therein how another method is used to fabricate further new mushroom-headed adhesive microstructures in accordance with a second embodiment of the invention.

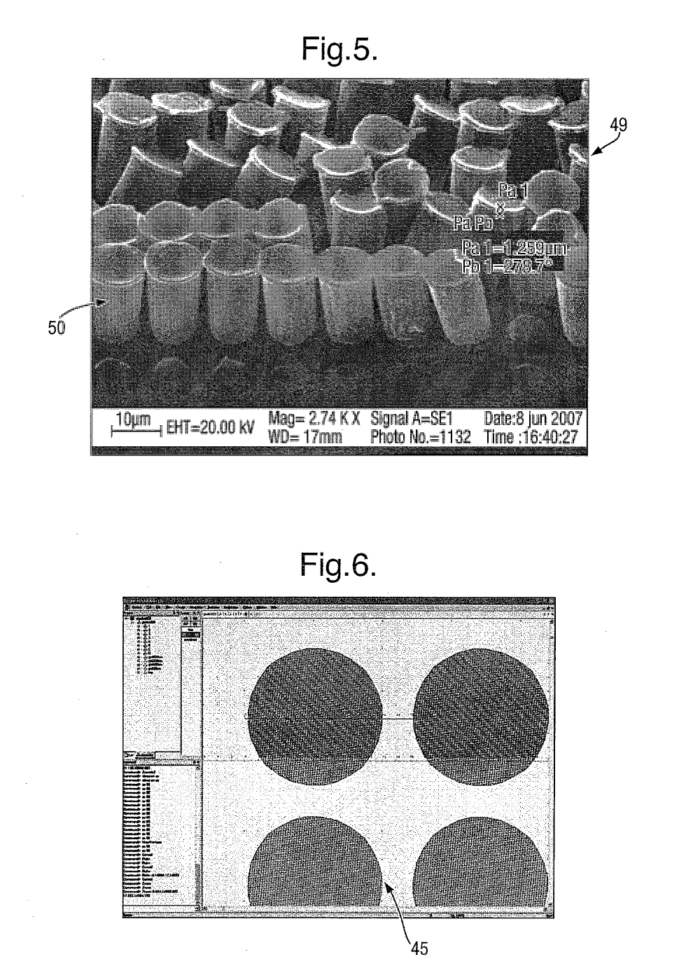

Wafers consisting of a 20 μm thick silicon layer on top of an oxide were obtained. These were patterned using negative versions of existing “coarse” and “fine” masks where, as in method 1 described above, blanking regions now defined the regions between hairs, rather than the hairs themselves. An example of a mask 45 defining the required features is shown in FIG. 6. This gave a series of patterns suitable for producing hairs of diameter between approximately 1 μm and 10 μm over each wafer. As will be readily understood by the man skilled in the art of lithography and etching techniques, the etching was conducted in a standard way (see method 1 etch parameters/procedures) and holes were fabricated through the 20 μm thickness of the silicon. The underlying oxide acted as an etch-stop boundary because it was found not to be sensitive to the reactive ion etching plasmas. Therefore, after etching to a 20 μm depth, the presence of the oxide at this junction resulted in increased etching of the side walls, resulting in re-entrant mushroom head structures. Moulding using the polymer PDMS was then performed as described above in method 1, and the mushroom-headed structures pulled from the silicon wafer mould as before. An example of the resulting structure 50 is shown in the image 49 of FIG. 5.

### Method 3 (Third Embodiment)

Referring again to FIG. 4, there is schematically shown therein the various steps (1. to 5.) of another method 55 of fabrication of new adhesive microstructures in accordance with a third embodiment of the invention.

As shown in FIG. 4, a 100 μm thick silicon wafer 60 is first obtained with shallow 40 μm diameter cylindrical cavities formed on one of its surfaces following the steps A. and B. of the above described method 1 (see FIG. 1). Next, a separate wafer 65 comprising 7 μm thick silicon layer on top of silicon oxide is obtained, and 3 μm diameter cylindrical cavities are then etched into this material extending through the 7 μm thickness of the silicon, following the procedure of the above described method 2 (Step 2.). The two wafers are then attached to each other at a surface 68 in such a way that the formed cavities in the wafers are made to coincide at the surface (Step 3.). We believe that the coincidence step is not critical to working this method. It is to be appreciated that the attachment step comprises bonding the wafers together using a standard bonding process, as would be readily understood by the man skilled in the art. In an alternative embodiment, the attachment step could comprise clipping the wafers together at the surface. With the wafers attached, a mask of the type used in method 1 (see FIGS. 2a, b and c) defining circular features (20 μm diameter) is then used to pattern the exposed top surface of the silicon wafer, and by applying lithography etching techniques in a standard way according to established etch parameters/procedures (see above described methods 1 and 2) as would be familiar to the man skilled in the art, 7 μm diameter cavities are etched into the silicon to provide various channels 70 which extend through the entire thickness of the silicon and which meet the formed cavities associated with the wafers at the attachment surface at selected areas (Step 4.). In this embodiment, the alignment of cavities at the surface is achieved using a commercially available Electronic Visions EV620 Bottom-Side Aligner with an alignment accuracy of 1 μm.

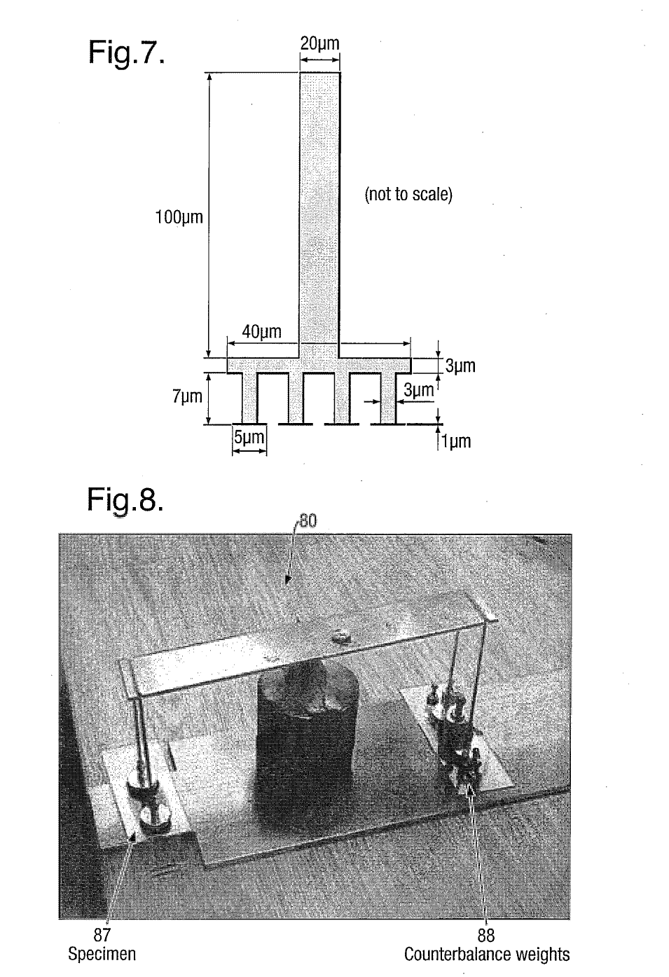

With the cavity and channel features so formed and aligned, a new silicon mould structure is thus achieved (see FIG. 7 for an exploded schematic view (in cross-section) of a channel formation in this structure). 7.5 g of liquid polydimethylsiloxane (PDMS) which in this embodiment is Sylgard 184 (supplier: Dow Corning) is then poured centrally onto the mould and carefully spread out in order to cover all the cavities. The PDMS covered mould is then placed into a vacuum chamber which is pumped down to a pressure of about 1 mbar and held for about 20 minutes so as to draw out all the air from the cavities. The chamber is then restored to atmospheric pressure and thereafter, the PDMS (Sylgard 184) is forced into the cavities. Upon completion of the forcing step of the PDMS into the cavities, the mould structure is cured at about 65° C. for about 4 hours to form a new adhesive microstructure 75 (see FIG. 4B) with small pads on fine hairs on top of large conformable pads which are in turn on large hairs (equivalent to 4 levels of compliance with a surface), which is then pulled out through the mould—Step 5. of FIG. 4 (the backing layer formed during the pull-out process is typically 1 mm or so thick).

FIG. 4B shows an exploded schematic view (not to scale) of a new adhesive microstructure 75 produced by the above described method 3. Typical dimensions of the structure are shown on the Figure. Note that the produced structure 75 has 4 levels of compliance, permitting a marked increase of contact area (typically covering 50 cm² areas) of the structure with a range of surfaces.

It is to be appreciated that the above described method 3 can be suitably modified to provide alternative new hierarchical structures having additional levels of compliance if desired. It is also to be appreciated that the silicon layer dimension and/or the cavity diameter dimensions in this embodiment could be varied typically by several μms, if desired, so as to provide the same inventive effect.

### EXPERIMENT

### A. Properties of Our Materials

An important variable controlling hair properties of our structures, including compliance, is recognised to be the modulus, hardness, tensile strength and tear strength. Proprietary brands of PDMS made and supplied by Dow Corning known as “Sylgard” are available in a range of different grades. In addition to the Sylgard 184 which was used in the Examples, Sylgard 186 and Sylgard 170 were also selected for evaluation using different moulds, including existing simple non-hierarchical moulds. As an additional option, Monothane with a Shore A hardness of 30 was obtained for evaluation. Monothane A30 is commercially available from Chemical Innovations Limited of Preston Lancashire UK (see website www.polycil.co.uk). Monothane is described as a single component, ester based, heat cure, castable polyurethane resin. Properties for each of these materials as used in the Examples are shown in Table 2 below. Further information on these materials was obtained by our own measurements or from the manufacturers' literature.

TABLE 2
Properties of the moulding polymers used in our Examples.

| | | | Tear | | |
|---|---|---|---|---|---|
| | | Tensile | Strength | Hard- | |
| | | strength | die | ness | Modulus |
| Material | Cure | (MPa) | B, kN/m | Shore A | (MPa) |
| Sylgard 170 | 30 mins | 2.4 | 3.5 | 41 | 0.65⁽⁷⁾ |
| | at 70 C. | | | | |
| Sylgard 184⁽³⁾ | 4 hrs | 7.1 | 2.6 | 50 | 0.75⁽⁶⁾, 1.3⁽⁷⁾ |
| | at 65 C. | | | | |
| Sylgard 186⁽³⁾ | 30 mins at | 4.8⁽³⁾ | — | ~30⁽³⁾ | 0.7⁽⁵⁾ |
| | at 100 C. | | | | |
| Monothane | 6 hrs | 8.3 | 1.2 (die C) | 30 | 1⁽⁴⁾ |
| A30⁽⁴⁾ | at 135 C. | | | | |

⁽³⁾G L Flowers and S T Switzer, “Background material properties of selected silicone potting compounds and raw materials for their substitutes”, 1978 May 01, Report No. MHSMP-78-18, http://www.osti.gov/energycitations/servlets/purl/7032853-hwLQRd/7032853.PDF.
⁽⁴⁾CIL Monothane Product Data, (4) Technical report “Empirical data on load extension for Monothane, PR-1564 and Neuthane 801”, TES 100770, Aug. 05, 2006.
⁽⁵⁾R. Pelrine, R. Kornbluh, J. Joseph, R. Heydt, Q. Pei, S. Chiba, High field deformation of elastomeric dielectrics for actuators, Mater. Sci. Eng. C 11 (2000) 89-100.
⁽⁶⁾http://mass.micro.uiuc.edu/publications/papers/136.pdf.
⁽⁷⁾http://www.lehigh.edu/~mkc4/our%20papers/She rolling.langmuir2000.pdf

### B. Assessment of Attachment Forces

Four different surfaces were used for assessment of attachment forces in our Examples. These were a smooth clean flat glass slide, a glossy painted aluminium surface typical of the quality used on the Hawk aircraft, a matt primer painted carbon fibre surface, and a matt primer painted aluminium surface. The matt painted aluminium surface had a small scale roughness with features of size typically ˜a whereas the matt painted carbonfibre reinforced plastic (CFRP) surface had both a small scale roughness and also a larger scale roughness with peaks and valleys with an amplitude of approximately 20 μm over distances of about 0.4 mm.

Attachment forces to the surface were measured in tension using a simple purpose-built balance at the Advanced Technology Centre, BAE SYSTEMS, Filton UK. FIG. 8 shows a perspective view of the purpose-built balance 80. The balance was constructed as a portable device in order that measurements of adhesive force could also be made inside a vacuum chamber. A knife edge was used as a simple pivot, and it was estimated that the balance had an ultimate sensitivity of approximately 0.01 grammes.

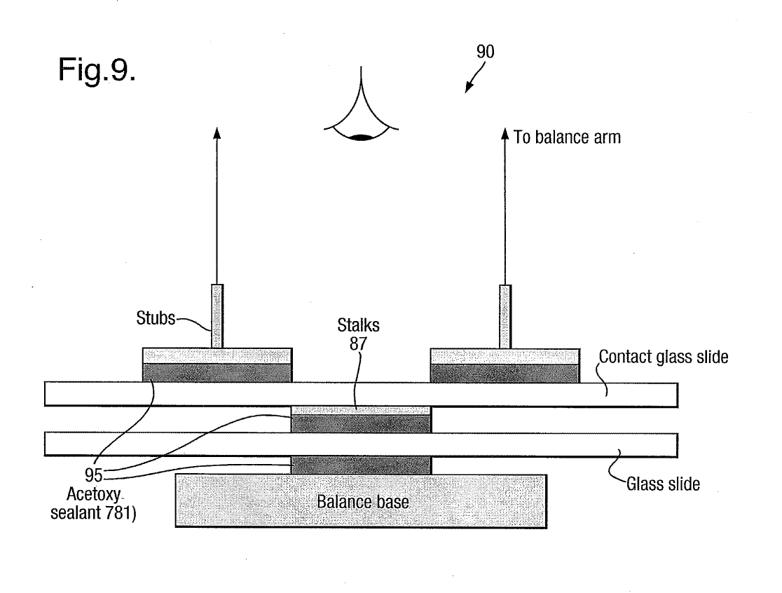

The specimen 87 was glued to the base of the balance and small mounting stubs were glued to the free surface of the glass slide. FIG. 9 shows in cross-sectional view (not to scale) the specimen assembly 90 mounted on the balance 80 of FIG. 8. A small thread was attached to the stubs. The thread was then attached to one of the lever arms of the balance, and a balancing weight 88 (as shown in FIG. 8, but not shown in FIG. 9) comprising stubs, adhesive layers and glass slide was mounted on the opposite lever arm. Balance in a neutral state with no load applied to the stalk contact area was achieved via the use of a small “rider” located on the balance arm. The stubs were mounted in such a way that the view of the contact area between stalks of the specimen and the lower surface of the glass slide was largely unobstructed. This permitted an assessment of contact area as the test proceeded.

Note that all examples of our adhesive material were bonded to a 12.5 or 25 mm diameter aluminium stub with Dow Corning Acetoxy Sealant 781—see 95 in FIG. 9.

It should be noted that all adhesion measurements irrespective of surface required a pre-load compressive force to be applied to the specimen in order to obtain attachment. This was achieved using between ˜20 g-˜130 g dead weight applied for periods of a few seconds to a few minutes when undertaking multiple re-attachment tests. Exceptionally when making initial measures of the first attachment strength, a few specimens were left with the dead weight in-situ on the surface overnight. These long pre-load times were dictated by the need to cure the backing sealant over several hours with an applied load in order to ensure a uniform bond line. In general, larger values of adhesive pull-off strength were obtained when longer timers and larger values of the dead weight were used for pre-loading.

Thus, the pull-off adhesion force measurements were made on the specimens using the purpose-built balance according to the following procedure: (a) by mounting the adhesive microstructure specimen under consideration on a glass surface, loading at successively increasing loads, and measuring the adhesion force alternately in an evacuated vacuum chamber (typically 1 mbar or less) and in air, thereby effectively enabling an elimination of the atmospheric contribution by noting that load at which the specimen detached when in a vacuum.

An assessment was also made of separation distance between glass surface and hair surface using standard optical interferometry techniques when measurements were made with a glass substrate. In addition, when making measurement of an average tensile pull-off strength with a glass surface as the contact, estimates of bonding area were made by viewing the actual contact area from the non-contacting rear surface of the glass surface. An assessment of contact area and tensile pull-off strength was found not to be possible when opaque surfaces such as the painted Hawk or CFRP surface was used. All adhesion measurements for specimens based on Type 1, 2 or 3 specimens (see also the Examples) are summarised in Table 3 below.

TABLE 3
Tensile pull-off loads for specimen Type 1, 2 and 3

| | | | | | | | Tensile | | |
|---|---|---|---|---|---|---|---|---|---|
| | | | Hair | Head | | Tensile | pull-off | | Contact |
| Specimen type | | Pad | length | diam. | Contact surface type. | pull-off | stress¹ | Specimen | area |
| and no. | Type | thickness | (μm) | (μm) | Air/vacuum | load (g) | (kPa) | dia (mm) | (m²) |
| No. 1. Sample 1A | Sylgard 184 | 3 | 100 | 40 | Smooth glass, air | 200 | ~160 | 12.5 | 1.23 × 10⁻⁵ |
| No. 1. Sample 1B | Sylgard 184 | 3 | 100 | 40 | Smooth glass, air | 350 | ~129 | 12.5 | 2.65 × 10⁻⁵ |
| No. 1. Sample 1B | Sylgard 184 | 3 | 100 | 40 | Smooth glass in vaccuum | 300 | ~111 | 12.5 | 2.65 × 10⁻⁵ |
| No. 1. Sample 1A | Sylgard 184 | 3 | 100 | 40 | Matt painted CFRP surface, | 0.5 | — | 12.5 | — |
| | | | | | air | | | | |
| No. 1. Sample 1A | Sylgard 184 | 3 | 100 | 40 | glossy painted metal, air | 155 | — | 12.5 | — |
| No. 1. Sample 1A | Sylgard 184 | 3 | 100 | 40 | matt painted metal, air | 39 | — | 12.5 | — |
| No. 1. Sample 1C | Sylgard 184 | 3 | 100 | 40 | Smooth glass, air | 2610 | 331 | 12.5 | 7.7 × 10⁻⁵ |
| No. 1. Sample 1D | Sylgard 184 | 3 | 100 | 40 | Smooth glass, air | 1413 | 180 | 12.5 | 7.7 × 10⁻⁵ |
| No. 1. Sample 1E | Sylgard 184 | 3 | 100 | 40 | Smooth glass, air | 2504 | 319 | 12.5 | 7.7 × 10⁻⁵ |
| No. 1. Sample 1F | Sylgard 184 | 3 | 100 | 40 | Smooth glass, air | 1978 | 252 | 12.5 | 7.7 × 10⁻⁵ |
| No. 1. Sample 1G | Sylgard 184 | 3 | 100 | 40 | Smooth glass, air | 2017 | 257 | 12.5 | 7.7 × 10⁻⁵ |
| No. 1. Sample 1H | Sylgard 184 | 3 | 100 | 40 | Smooth glass, air | 3485 | 444 | 12.5 | 7.7 × 10⁻⁵ |
| No. 1. Sample 1J | Sylgard 184 | 3 | 100 | 40 | Smooth glass, air | 3461 | 441 | 12.5 | 7.7 × 10⁻⁵ |
| No. 1. Sample 1K | Sylgard 184 | 3 | 100 | 40 | Smooth glass, air | 3980 | 507 | 12.5 | 7.7 × 10⁻⁵ |
| No. 1. Sample 1L | Sylgard 184 | 3 | 100 | 40 | Smooth glass, air | 3783 | 482 | 12.5 | 7.7 × 10⁻⁵ |
| No. 1. Sample 1M | Sylgard 184 | 3 | 100 | 40 | Smooth glass, air | 3587 | 457 | 12.5 | 7.7 × 10⁻⁵ |
| No. 1. Sample 1N | Sylgard 184 | 3 | 100 | 40 | Smooth glass, air | 3250 | 414 | 12.5 | 7.7 × 10⁻⁵ |
| No. 1. Sample 1O | Sylgard 184 | 3 | 100 | 40 | Smooth glass, air | 2135 | 272 | 12.5 | 7.7 × 10⁻⁵ |
| No. 1. Sample 1P | Sylgard 184 | 3 | 100 | 40 | Smooth glass, air | 1931 | 246 | 12.5 | 7.7 × 10⁻⁵ |
| No. 2. Sample 2A | Sylgard 184 | 1 | 100 | 40 | Smooth glass, air | 1200 | ~192 | 12.5 | 6.1 × 10⁻⁵ |
| No. 2. Sample 2A | Sylgard 184 | 1 | 100 | 40 | Matt painted CFRP surface, | 3 | — | 12.5 | — |
| | | | | | air | | | | |
| No. 2. Sample 2A | Sylgard 184 | 1 | 100 | 40 | glossy painted metal, air | 120 | — | 12.5 | — |
| No. 2. Sample 2B | Sylgard 184 | 1 | 100 | 40 | Matt painted metal, air | 49 | — | 12.5 | — |
| No. 3. Sample 3A | Sylgard 184 | 1 | 20 | 10 | Smooth glass, air | 750 | ~219 | 12.5 | 3.3 × 10⁻⁵ |
| No. 3. Sample 3A | Sylgard 184 | 1 | 20 | 10 | Matt painted CFRP surface, | 1 | — | 12.5 | — |
| | | | | | air | | | | |
| No. 3. Sample 3A | Sylgard 184 | 1 | 20 | 10 | glossy painted metal, air | 53 | — | 12.5 | — |

¹Notes: Stress was calculated based on the actual contact area of hairs with the surface, and not the total average contact area.

We envisage improvements in our fabrication techniques to increase the actual contact area of our specimens with the contact surface in proportion to the total contact area.

### Adhesion Measurements and Contact Assessment

### Interferometry and Contact Assessment on Structured (PDMS) Stalk Specimens

A pre-requisite for obtaining adhesion is that intimate contact is achieved between the top of the stalks of the specimen in question and the contacting surface. For Van der Waals' forces to operate, intimate contact between the stalks and the surface is achieved when the separation distances are typically less than 10 nm.

A key requirement to achieving intimate contact is the ability of the specimen structure in question to conform to the contact surface. A glass slide was used by the inventors as a suitable reference contact surface. This was found to provide a convenient surface which was flat, smooth and could easily be cleaned.

By careful arrangement of illumination and observation angle, it was possible to observe visually the formation of interference fringes formed in the cavity between the lower surface of the glass slide which was in contact with the structured PDMS surface, and the top surfaces of the PDMS stalks.

FIG. 11 shows an image recorded for a “Type 1” (see below) specimen, using oblique white light illumination. Interference fringes (coloured) are visible across the specimen surface indicating a gap of variable width between the glass surface and the stalk tops. The dark regions in the Figure represent regions of intimate contact between the glass surface and the stalk tops. As will be understood by the man skilled in the art, interpretation of the colour of the interference fringes in terms of interfacial gap widths can be made by reference to a chart such as the “Michel-Levy Interference colour chart”. This chart, as is well-known, relates the retardation in birefringence measurements to interference colour, and is commonly used to measure the optical path difference between polarisation states. In the context used here, the interference colours are understood to arise as a result of the optical path difference formed in the cavity created by the lower surface of the glass slide and the top of the stalks, and the optical retardation as given by a particular colour in the chart indicates twice the interfacial gap width.

### Examples 1 and 2

### Type 1 Specimens

Hierarchical mushroom structure, Sylgard 184, hair length 100 μm, hair diameter 20 μm, head diameter ˜40 μm, head thickness 3 μm, 12.5 mm backing stub (above described Method 1).

### Example 1

Above described method 1 was used (refer to FIG. 1).

A patterned mask defining circular features (40 μm diameter) was used (see FIGS. 2a, b and c) to pattern one side of a silicon wafer (100 μm thickness, 100 mm size wafer) with resist, and by applying standard lithography and reactive-ion etching (RIE) techniques known to the man skilled in the art (refer to parameters in method 1), 40 μm diameter cylindrical cavities were etched into the silicon material to a depth of approximately 3 μm. The silicon wafer was then bonded to an SD2 glass substrate of 500 μm thickness, 100 mm diameter (SD2 glass is known to be closely thermally matched to silicon; SD2 glass can be purchased from Hoya—see Hoya Optics website: www.hoyaoptics.com), positioning the generated 40 μm diameter cavities at the SD2 glass/silicon interface. The bonding was effected using an anodic bonding process of the type described in Wallis, Pomerantz and Field's paper on assisted glass-metal sealing (J. App. Phys. 40 (1969) 563-567). Note that the anodic bonding process used in this Example was conducted in an Electronic Visions EV501 machine—this bonding process comprises forming a bond at a temperature of 400° C. or so under vacuum, and applying three voltage steps ranging from 400V up to 800V. It will be appreciated that the purpose of the SD2 glass substrate is to provide a sufficiently flat surface for moulding the new mushroom-shaped adhesive microstructure. It is also to be appreciated that the SD2 glass substrate is selected to have sufficient thickness to permit mechanical handling.

A patterned mask defining circular features (20 μm diameter) was then used to pattern the exposed top surface of the silicon wafer, and again by applying standard lithography and deep reactive-ion etching (DRIE) techniques well known to the man skilled in the art (see also DRIE references: R B Bosch Gmbh 1994 U.S. Pat. No. 4,855,017 and German patent no. 4241045C1; Lithography reference: Sze VLSI Technology, 2^{nd} Ed., McGraw Hill Book Co. 1988), 20 μm diameter cavities were etched into the silicon to form channels extending through the entire thickness of the silicon and which meet the formed 40 μm diameter cavities about a common axis. Alignment of the formed 20 μm and 40 μm diameter cavities about a common axis to within an accuracy of ˜1 μm was achieved using an Electronic Visions EV620 Bottom-Side Aligner. With the cavity features thus formed and aligned, a new silicon mould structure with channel formations was obtained. FIG. 15 is an exploded schematic view (in cross-section) of a channel formation 250 in this structure. The dimensions of the channel feature 250 are shown on the Figure.

7.5 g of liquid PDMS (Sylgard 184 supplied by Dow Corning) was poured centrally onto the mould of FIG. 15, and carefully spread out in order to cover all of the cavities. The PDMS covered mould was then placed into a vacuum chamber which was pumped down to a pressure of 1 mbar and held for about 20 minutes in order to draw all the air out from the cavities. Thereafter, the chamber was brought back to atmospheric pressure and the PDMS was forced into the cavities. Once all the liquid PDMS had been introduced into the mould in this way, the mould was thermally cured at about 65° C. for a duration of about 4 hours to form a new mushroom-shaped structure with stalks which was then pulled-out through the mould.

FIG. 3 shows the resultant new structure 40 produced in this Example. As can be seen in the Figure, this particular structure has a stalk length of 100 μm, stalk diameter of 20 μm, and a head thickness of 3 μm.

According to this Example, new adhesive structures (of the type shown in FIG. 3) can be produced to cover the entire silicon wafer diameter.

### Example 2

Example 1 was repeated but instead of using SD2 glass substrate, a pyrex glass substrate was used.

A new structure of the type shown in FIG. 3 was produced in this Example.

### Test Results

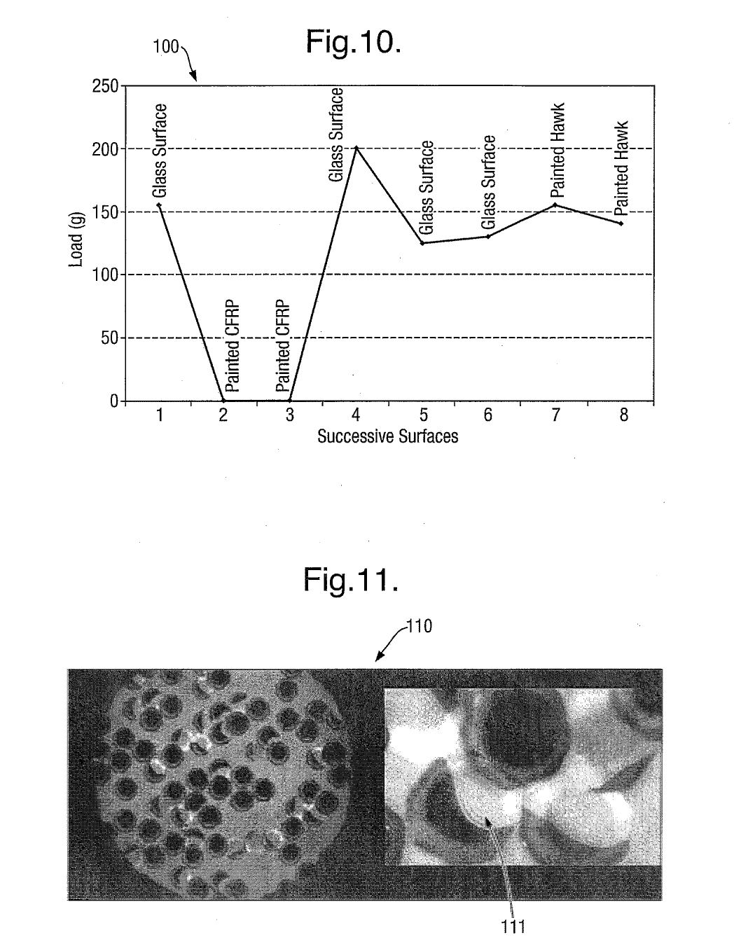

An example of a specimen of this type (see the image in FIG. 3) was tested successively to give measurements of tensile pull-off strength on a smooth glass slide using the rough painted carbonfibre reinforced plastic (CFRP) specimen and the glossy painted Hawk surface. FIG. 10 shows the forces recorded at each stage 100. A separate specimen of this type was also tested on the matt painted aluminium surface, for which a maximum load of 39 g was measured.

Inspection of FIG. 10 shows a maximum load of 200 g on the glass surface, 155 g on the glossy painted Hawk surface and only 0.5 g on the matt painted CFRP surface.

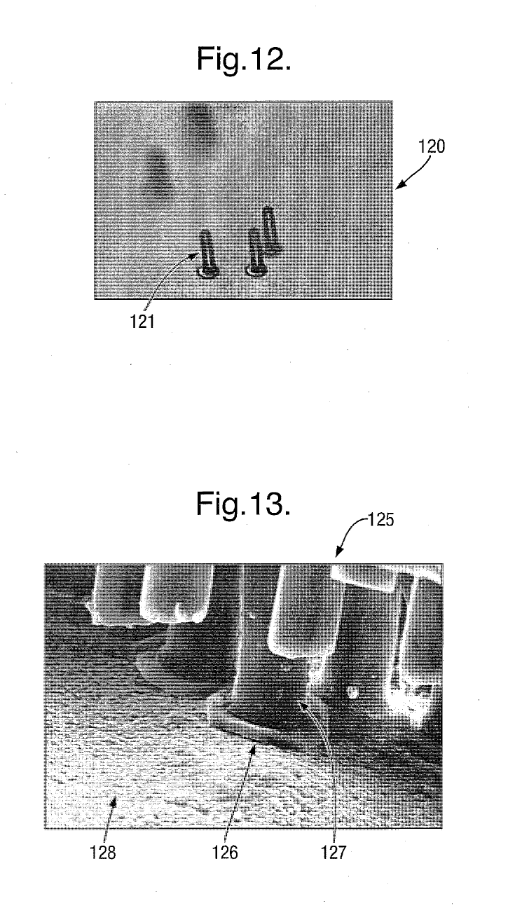

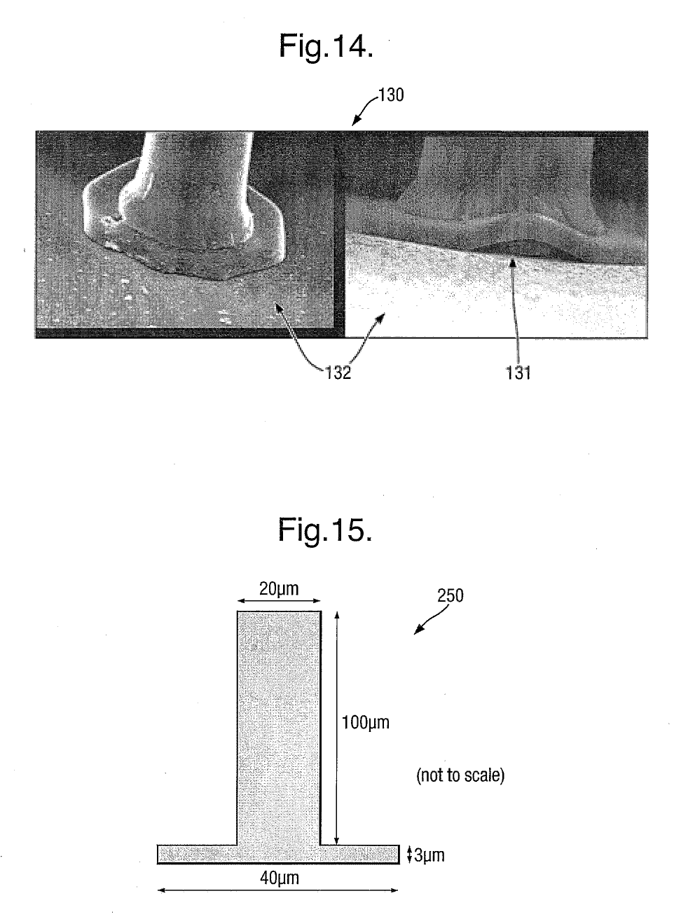

FIG. 11 shows a photomicrograph 110 of the contact area for this specimen on the glass surface. Inspection of FIG. 11 shows both interference fringes 111 and areas of good contact (uniform grey contrast). The hair contact area fraction was estimated to be approximately 22% of the available stub area, which was approximately 50%. This gave an equivalent maximum tensile strength of ˜160 kPa for a glass surface adhesion force of 200 g. After adhesion testing of the specimen it was noticeable that some hairs 121 had become detached from the PDMS backing and remained in contact with the glass slide. These are shown in the photomicrograph 120 of FIG. 12. FIG. 13 is a photomicrograph 125 showing contact 126 of a hair 127 with the painted CFRP surface 128, and FIG. 14 is a photomicrograph 130 showing contact with the glossy Hawk paint surface 132. The small scale and large scale roughness of the painted CFRP surface is evident in FIG. 13, and the deformation of the hair head 131 to accommodate a small dust particle is apparent in FIG. 14.

These results show that the best contact, as seen in FIG. 11 for the glass surface and in FIG. 14 for the glossy painted Hawk surface, also gave the highest adhesion forces. In fact, the bond was found to be so strong in some instances with the glass surface that as shown in FIG. 12, a few hairs broke away from their base rather than the glass surface. Intermediate contact as noted from the intermediate measured adhesion force was achieved with the matt painted aluminium surface, indicating that some contact was achieved with the small scale roughness. Least contact, as seen in FIG. 13 for the matt painted CFRP surface, with the lowest adhesion force, was probably due to the inability of the hair array to conform primarily to the larger scale roughness.

Given that the hierarchical head resembled very small suction pads, it was of interest to ascertain the extent to which the component of adhesion to a surface was due to molecular forces, such as Van der Waals' forces, and that due to atmospheric forces. As described previously using the balance, by mounting a new hierarchical specimen on a glass surface, loading at successively increasing loads, and measuring the adhesion force alternately in an evacuated vacuum chamber and in air, it was possible to eliminate the “atmospheric contribution” by noting that load at which the specimen detached when in a vacuum. This showed first detachment in vacuum at 300 g. A load of 300 g implied a molecular contribution of ˜111 kPa. Since a specimen of the same Type 1 (different sample—see Table 3) had already failed in air at 160 kPa, this implied there was also an “atmospheric contribution” of at least 49 kPa, and that potentially with a “full atmospheric pressure contribution” of 100 kPa such a specimen should ultimately give at least an adhesion strength of ˜211 kPa.

### Example 3

### Type 2 Specimens

Hierarchical mushroom structure, Sylgard 184, hair length 100 μm, hair diameter 20 μm, head diameter ˜40 μm, head thickness 1 μm, 12.5 mm backing stub (Method 1).

Above described method 1 was used in this Example (refer to FIG. 1).

In an attempt to improve adhesion to the rough painted CFRP surface, specimens with 1 μm thick mushroom heads were fabricated. Example 1 was repeated, but the shallow etch depth in the silicon was limited to 1 μm or so (instead of 3 μm). This was done by a routine variation of the etch parameters (based on the method 1 parameters), as would be understood by the man skilled in the art.

The resulting fabricated new structures were found to be similar in most respects to the type 1 specimens produced in Examples 1 and 2, except for the more compliant head feature which it was hoped would conform better to the small scale roughness of the surface.

### Test Results

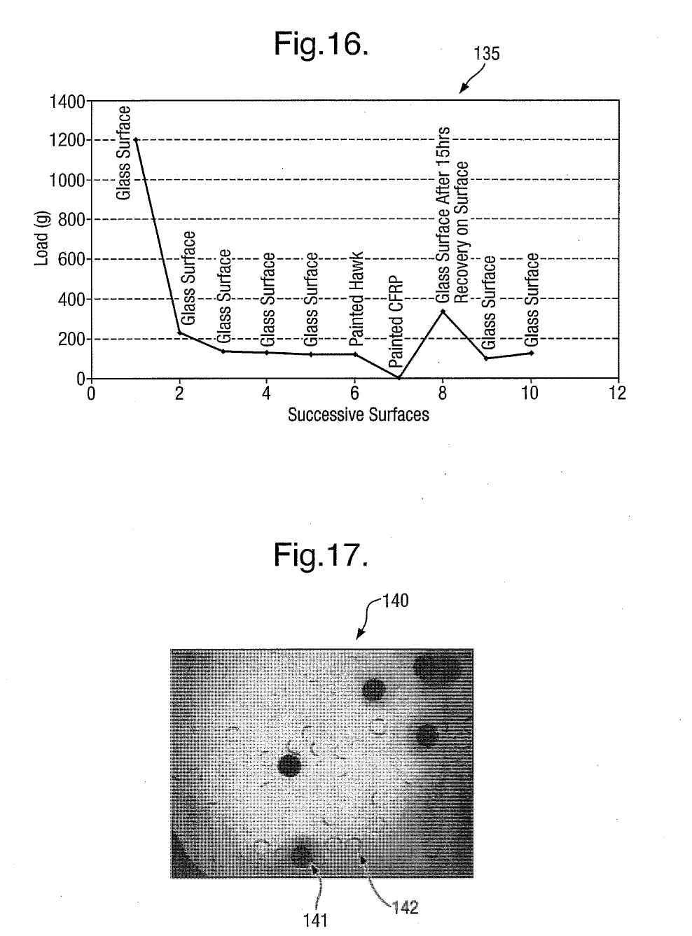

An example of this specimen was tested successively for the tensile pull-off strength on a smooth glass slide, the glossy pointed Hawk surface and the rough painted CFRP surface. FIG. 16 is a graph 135 showing the forces recorded at each stage.

Inspection of FIG. 16 shows a maximum load of 1200 g on the glass surface, 120 g on the glossy painted Hawk surface and ˜3 g on the painted CFRP surface. The hair contact area fraction was estimated to be approximately 52% over the whole of the stub area, giving an equivalent maximum tensile strength of 192 kPa for a glass surface adhesion force of 1200 g. After the first detachment of the specimen from the glass surface at the very large load of 1200 g, it was noted that hairs had become both detached, in a similar fashion as shown for specimen type 1 in FIG. 12 above, and also left small ring shaped remnants of material on the glass surface. These remnants 142 together with a few detached hairs 141 are shown in the optical photomicrograph 140 in FIG. 17. It was noticeable that remnants 142 were only visible in a ring near the free unsupported edge, and not in the central part of the mushroom head. These remnants were also more noticeable here than with the 3 μm thick mushroom head specimen 1 tested previously. A separate specimen of this type was also tested on the matt painted aluminium surface for which a maximum load of 49 g was measured.

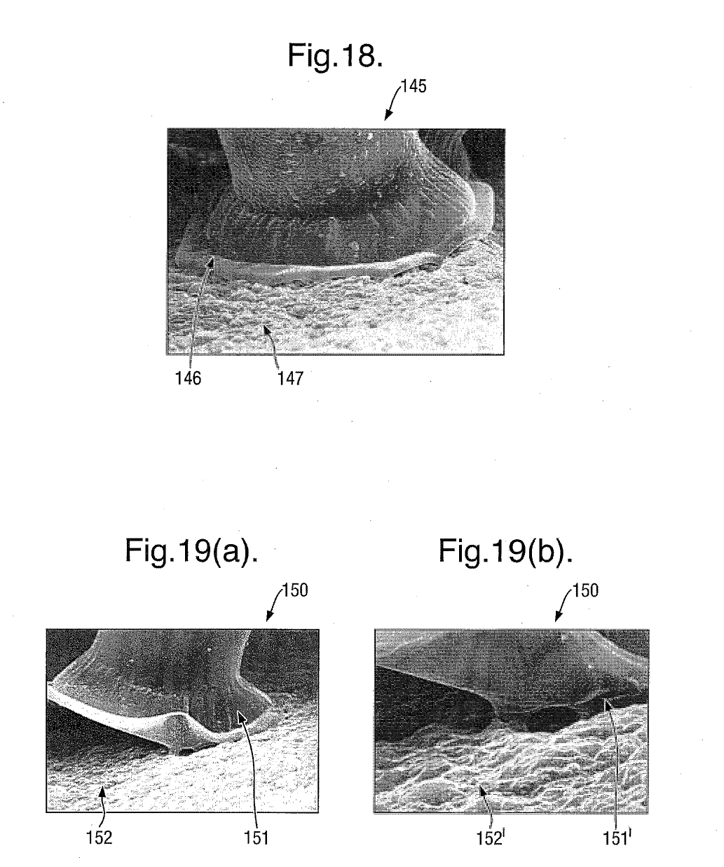

FIG. 18 shows an SEM image 145 for specimen type 2 on the painted CFRP surface 147. Conformation of the mushroom head 146 with the surface 147 in this instance appeared to be better than that seen for the equivalent 3 μm headed structure shown previously in FIG. 13 above. Insofar as the adhesion force for the matt painted aluminium surface was larger here than that measured for specimen type 1 on the same surface, this suggests that the thinner head was better able to conform to the small scale roughness. FIGS. 19(a) and (b) are images 150 which show detail of the mushroom head 151, 151′ in contact with the rough CFRP surface 152, 152′ where material is apparently in the process of breaking away from the head of the hair. It is not understood exactly why this is occurring. It is suggested that the ring shaped remnants observed in FIG. 17 had the same origin as the detaching fragment seen in FIGS. 19(a) and (b).

### Example 4

### Type 3 Specimens

Hierarchical mushroom structure, Sylgard 184, hair length 20 μm, hair diameter 8 μm, head diameter ˜10 μm, head thickness ˜1 μm (Method 2).

Above described method 2 was used in this Example (refer to FIG. 4—step 2.).

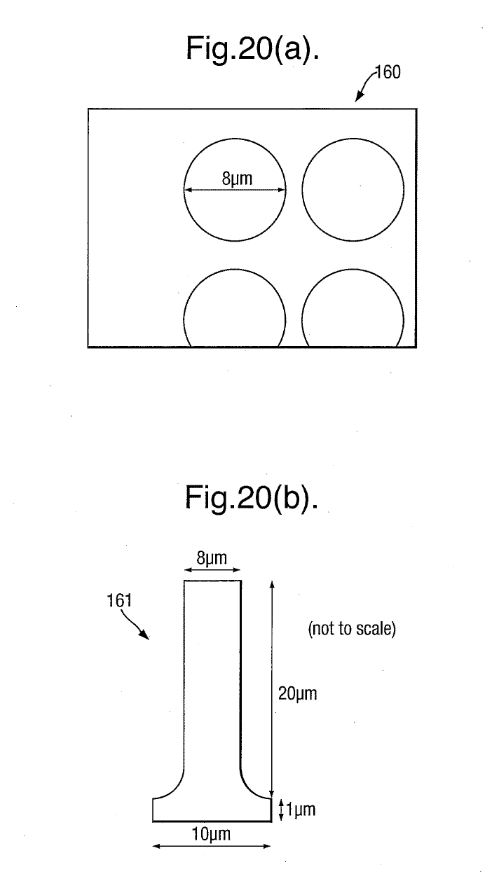

A wafer comprising a 20 μm thick, 100 mm diameter silicon layer on top of a 1 μm thick silicon oxide layer (the layer covering the entire wafer) was obtained. Such a wafer was purchased from the manufacturer Virginia Semiconductor Inc. (see their website: www.virginiasemi.com). A mask (of the type shown in FIG. 6) defining 8 μm circular diameter features was then used to pattern the exposed side of the silicon layer, and by applying the same standard lithography and reactive-ion etching techniques as described in Example 1 above, 8 μm diameter cylindrical cavities were etched into the silicon extending through the 20 μm thickness of the silicon. It has been found in this Example that the underlying silicon oxide of the wafer acts as an etch-stop boundary because it is not sensitive to the reactive-ion etching plasma as applied to the structure. We have found that silicon deep reactive-ion etching processes demonstrate higher selectivity to silicon dioxide than to silicon, in the ratio of ˜50:1. With the etching and cylindrically symmetric cavities formed and effected through the silicon up to a depth of 20 μm to form a silicon mould having 8 μm channel features and pitch of 10 μm (as shown in plan view 160 in FIG. 20(a), and in exploded cross-section view 161 in FIG. 20(b)), 7.5 g liquid PDMS (Sylgard 184 as supplied by Dow Corning) was introduced into the mould in exactly the same way and under the same conditions as described in the previous Examples (Examples 1 to 3) to form a new mushroom-shaped structure with stalks which was then pulled out through the mould. The pulling out step was effected in the same fashion as specified in the previous Examples (Examples 1 to 3).

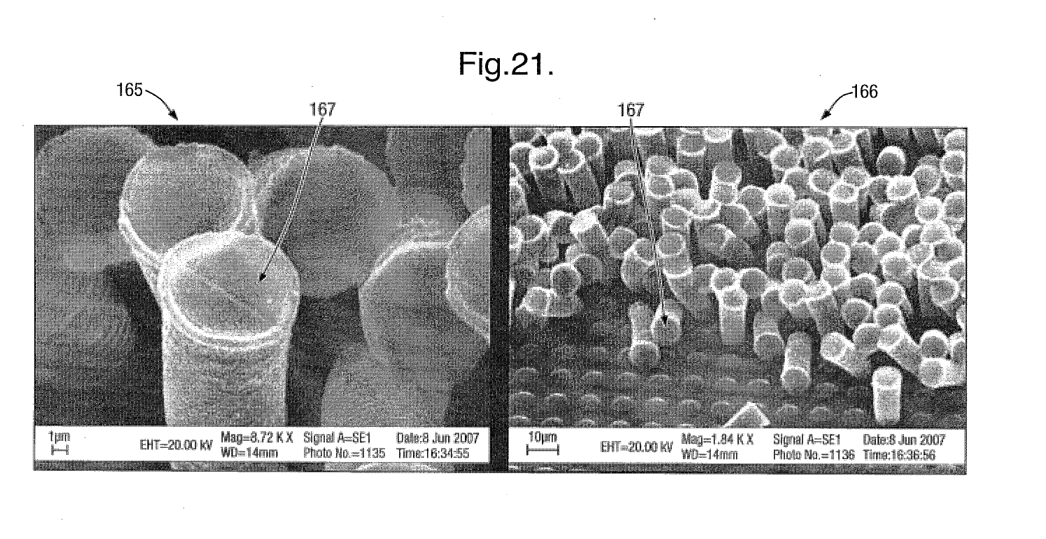

FIG. 21 (with scale bar/magnification indicated) shows images 165, 166 of a new structure 167 with disk-like features on stalk ends (head ˜10 μm diameter), as produced in this Example by performing the above described method 2. Large areas of the structure can be made according to this Example, as required. As in Examples 1 to 3, the new structures made can cover the whole wafer diameter.

It has been thus found in this Example that the presence of the silicon oxide at the silicon/silicon oxide function resulted in increased etching of the side walls, resulting in the successful production of re-entrant mushroom head structures with disk features on stalk ends (as shown in the SEM images of FIG. 21).

### Example 5

Hierarchical mushroom structure with enhanced mushroom head shapes, Sylgard 184, head diameter>10 μm (Method 2).

The procedure as specified in Example 4 was used. Structures of the type fabricated in Example 4 were then modified to provide deliberately enhanced mushroom head shapes by controllably depositing layers of the etch-resistant polymer material into the mould structure. This modification step was effected in accordance with a known etching procedure known as “footing”, as applied to mushroom-type structures (see on “footing”, the paper by Hwang, Gyeong, Giapis, and Konstantinos: “On the origin of the notching effect during etching in uniform high density plasmas (1997), Journal of Vacuum of Science and Technology B, 15(1) pp 70-87).

### Test Results

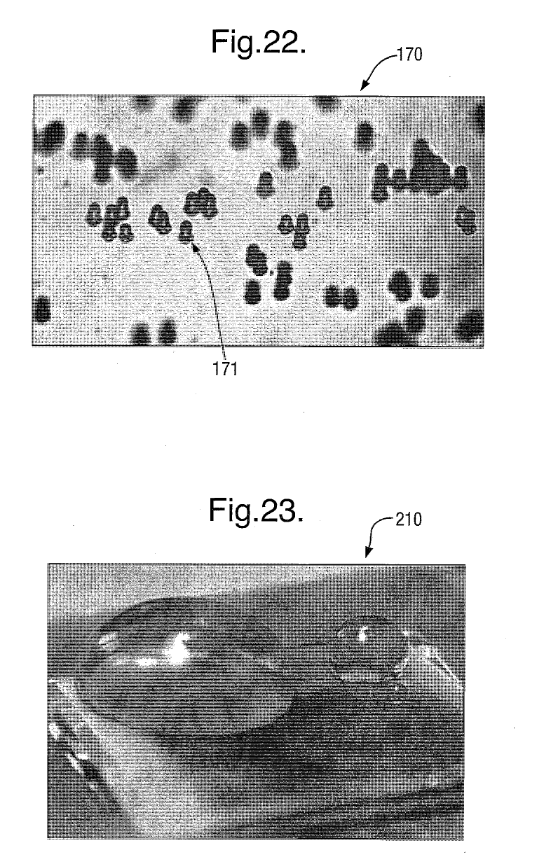

Successive tensile pull-off strengths were measured on the Example 4 type 3 specimen using the surfaces of a smooth glass slide, the rough painted CFRP specimen and the glossy painted Hawk. A maximum load of 750 g was measured on the glass surface, 53 g on the glossy painted Hawk surface and ˜1 g on the painted CFRP surface. The hair contact area fraction was estimated to be approximately 27% over the whole stub area, giving an equivalent tensile strength of 219 kPa for a glass surface maximum adhesion force of 750 g. After the first detachment of the specimen from the glass surface it was again noted that hairs had become detached in a similar fashion to that shown for specimen type 1 in FIG. 12 and for specimen type 2 in FIG. 17 above. The detached hairs 171 are shown in the optical photomicrograph 170 in FIG. 22.

### Double-Sided Adhesive Microstructure—Sylgard 184

### Example

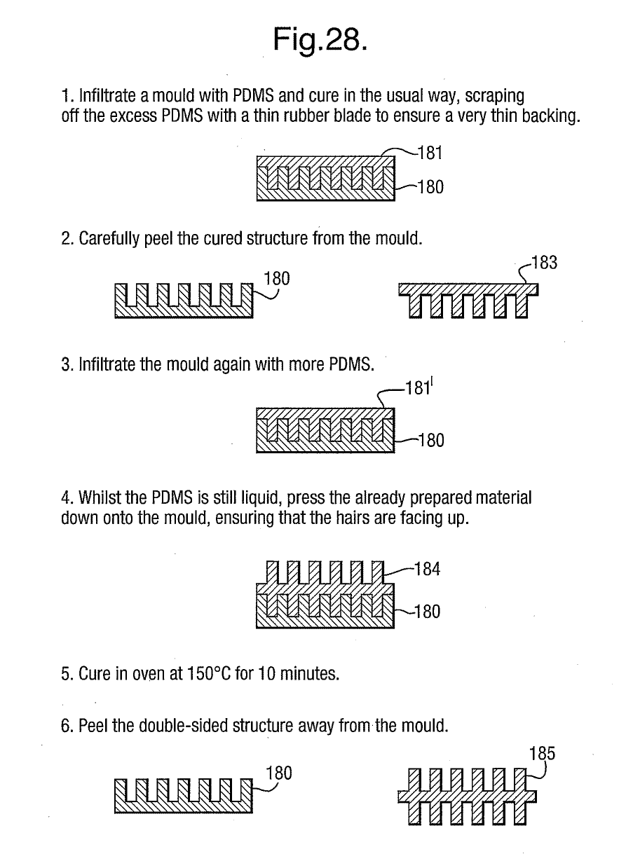

In this Example, a new double-sided adhesive microstructure was fabricated via moulding. The fabrication steps are shown schematically in steps 1. to 6. of FIG. 28 (structures shown are not to scale).

A silicon mould 180 was obtained as described in Example 1 above. 7.5 g of liquid PDMS 181 (Sylgard 184 supplied by Dow Corning) was then introduced by pouring it into the mould 180, exactly as described in Example 1, and then the mould was thermally cured at about 65° C. for a duration of about 4 hours whilst ensuring excess PDMS material was scraped off the mould with a thin rubber blade to provide a very thin backing (of ˜200-300 μm)—step 1. The resulting cured structure was then pulled out through the mould (step 2.). The pull out step involved the following: (i) carefully cutting around the edge of the mould with a sharp scalpel blade to provide an easy to peel edge, (ii) prising up one edge of the cured adhesive material with the scalpel blade and (iii) peeling the cured adhesive material up very carefully and slowly by hand using a 90° peel angle. We found that the peeling of a 4 inch diameter adhesive material usually took 2-3 minutes. This prepared adhesive material 183 was then put to one side.

Next, the silicon mould 180 was refilled with more liquid PDMS material 181′ (7.5 g, Sylgard 184 as before) exactly as described before (step 3.), and whilst the PDMS 181′ was still liquid, the already prepared adhesive material 183 (as described in this Example) was pressed down onto the mould 180 ensuring that the hairs were facing up (step 4.). The structure was then cured in an oven at about 150° C. for about 10 minutes (step 5.). The cured structure was then pulled out through the mould (step 6.) to provide the double-sided adhesive structure 185. This pull-out step was effected in the same way as the first pull out step (already described in this Example).

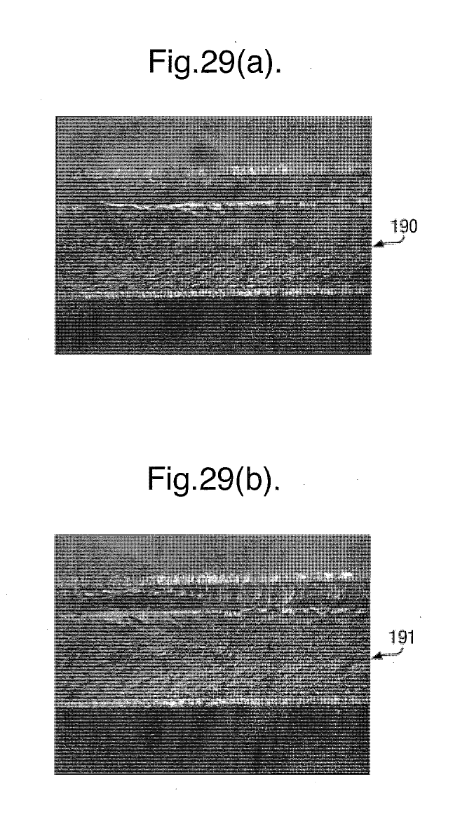

FIGS. 29(a) and (b) show images 190, 191 of the double-sided adhesive structure as produced by the method according to this Example. Note in these images the formation of separate adhesive layers on opposing surfaces of the structure.

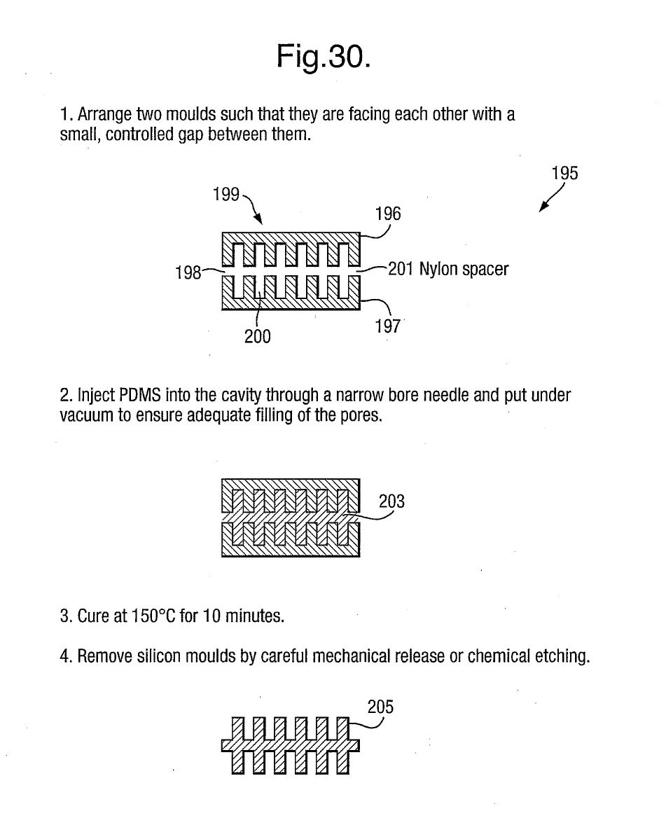

Referring next to FIG. 30, there is schematically shown (not to scale) therein the steps (1. to 4.) of another method 195 of fabrication of a double-sided adhesive microstructure.

Two separate silicon moulds 196, 197 are obtained. Each of the moulds could be obtained as described in Example 1 above. The moulds 196, 197 are then positioned close together in face-to-face relationship with a small controlled spacing 198 between them, defining a new mould structure 199 having a cavity region 200. A nylon spacer 201 is used to control the spacing between the moulds (step 1.). Liquid PDMS is then injected into the cavity region through a narrow bore needle (not shown) and the structure is then put under a vacuum to provide adequate filling of the structure pores (step 2.). Once the structure pores are adequately filled 203, the structure is cured in an oven at about 150° C. for 10 minutes (step 3.). Thereafter, the moulds are removed by careful mechanical release or by chemical etching (step 4.) to leave behind formation of the doubled-sided adhesive structure 205.

It is to be understood that other kinds of mould could equally be used in this method instead of the silicon moulds—for example, the use of polyimide moulds is envisaged to be amenable to this method.

It is believed that the foregoing Examples and embodiments provide ample instruction to the man skilled in the art to put the present invention into effect, but for the sake of completeness there is also provided below a discussion of the results and of some further tests and experiments on the polymers specified in Table 2.

### Discussion of Results

We have found that our fabricated adhesive structures surprisingly exhibit significantly improved adhesion strengths of up to ˜220 kPa at least at a smooth glass surface, as compared to ˜30 kPa adhesion strengths for known fabricated adhesive structures. Various workers have measured pull-off loads on specimens under different conditions, and for the sake of completeness, all the values collated to date are set out in Table 4 below.

TABLE 4
List of adhesion strengths for synthetic and real gecko materials.

| | Type of | | | | |
|---|---|---|---|---|---|
| Author | measurement | Material | Value | | Comments |
| Geim et al (8) | Pull-off | polyimide | 30 | kPa | |
| laims.doc₁ | | | | | |
| Geim et al (8) | Pull-off | Real Gecko pads | 100 | kPa | |
| Gorb et al (10) | peeling | PVS | 1.38 | J/m² | |
| C Y Hui et al (11) | Pull-off | PDMS | 83 | mN | 5 mm × 5 mm array of 1 μm |
| | | | | | dia, 3 μm spacing |
| Sitti et al, (12) | Synthetic nano hair | PDMS and polyester | 60-300 | nN | Per hair |
| | AFM measurement | | | | |
| Autumn et al, (13) | Single Gecko setae, | Real Gecko | 200 | μN | Per setae (~1000 spatulae) |
| | AFM pull-off | | | | |
| Autumn et al (14) | Single PDMS | PDMS | 181 | nN | Per hair, tip radius 230-440 nm |
| | spatulae, AFM | | | | |
| Autumn et al (14) | Single polyester | polyester | 294 | nN | Per hair, tip radius ~350 nm |
| | spatulae, AFM | | | | |
| Sun et al, (15) | AFM | Real gecko | ~5-12 | nN | Per hair |
| Kesel et al. (9) | AFM | Jumping spider | 224 | kPa | Average |
| Autumn (16) | Estimate from | Real gecko | ~40 | nN | Per spatulae |
| | literature values | | ~2000 | kPa | |
| Persson (17) | Derived form | Real Gecko | ~40 | J/m² | |
| | adhesion force | | | | |

(8) A. K. Geim, S. V. Dubonos, I. V. Grigorrieva, K. S. Novoselov, A. A. Zhukov and S. Yu. Shapoval, “Microfabricated adhesive mimicking gecko foot-hair”, Nature Materials, Vol. 2, July 2003, 461.
(9) Kesel et al, The J of Exp. Biol., 2003, 206, 2733.
(10) S Gorb et al, J. R. Soc. Interface, 2006.
(11) C.-Y Hui et al, J R Soc. Interface, 2004.
(12) Sitti et al, J Adhesion Science and Tech. 2003, Vol 18, no. 7, p 1055.
(13) Autumn et al, Nature, 405: 681-8685, 2000b.
(14) Autumn et al, PNAS, www.pnas.org/cgi/doi/10.1073/pnas.192252799
(15) Sun et al, Biophysical Journal: Biophysical Letters, 2005.
(16) Autumn, “Properties, principles and parameters of the gecko adhesive system, In Smith and Callow, Biological Adhesives, Springer Verlag, 2006.
(17) B N J Persson, J Chem Phys, Vol 118, No 16, 2003, 7614.

It is suggested that the significantly raised adhesion strengths of ˜220 kPa of our structures at least on a smooth surface such as smooth glass are due to an atmospheric “suction cup” and molecular (Van der Waals') component of force which typically contribute in roughly equal measure; thus, it is likely that whereas on smooth surfaces such as glass or glossy paint this full adhesion strength can be achieved, on other rougher surfaces where it is not possible to obtain any such atmospheric “suction cup” contribution, the strengths are significantly reduced to a maximum strength of ˜100 kPa. It is also recognised that roughness of surface results in less intimate contact which in turn causes a reduction in the adhesion strength. We thus propose to undertake further studies to accommodate several scales of surface roughness. It was found to be possible in these studies to deal with very small scale roughness of ˜1 μm successfully by means of reducing head thickness of our structures. To accommodate several scales of roughness, it is suggested we fabricate that new structures in accordance with the invention having additional scales of hierarchical compliance in relation to surfaces having larger scales of roughness.

In this connection, we have found that the above described method 3 can be used to fabricate new adhesive structures in accordance with the invention having multiple levels of hierarchical compliance with a surface. Significantly, it is to be noted that our proposed scheme bears the tremendous potential for producing large scale specimens with four levels of hierarchical compliance (see FIG. 4B) in relation to a surface.

### Specimen Types 4, 5 and 6—Monothane, Sylgard 170 and 186

In addition to Sylgard 184 which was used in the above described Examples 1 to 5, some tests on moulding and contact with surfaces were carried out using other polymers with properties shown in Table 2. Moulds of the kind described in Examples 1 to 5 were used in the tests.

The results obtained to date suggest to the inventors that, by using different new moulds for Monothane A30 and Sylgard 170, such polymers could be used to advantage in the present invention.

### Type 2 Specimens—Cleaning and Contamination Experiments

It was noted that the specimens used here exhibited superhydrophobic properties. This property is manifest as a very hydrophobic surface which exhibits no wetting, and is shown in the image 210 of FIG. 23 for a simple, non-hierarchical specimen having hairs of diameter 8 μm. PDMS is inherently hydrophobic, but patterned PDMS exhibits extreme non-wetting behaviour, such that water forms into balls and rolls off the surface with little resistance. This behaviour is observed in some biological systems, most notably in lotus leaves, and is termed the “lotus” effect. This is a natural cleaning mechanism whereby mud, tiny insects, and contaminants are swept away by water droplets rolling off the leaf surface without the leaf getting wet.

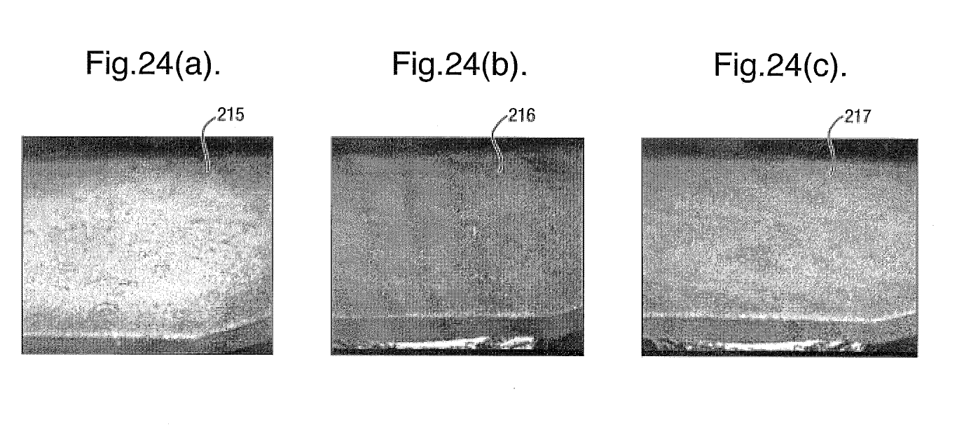

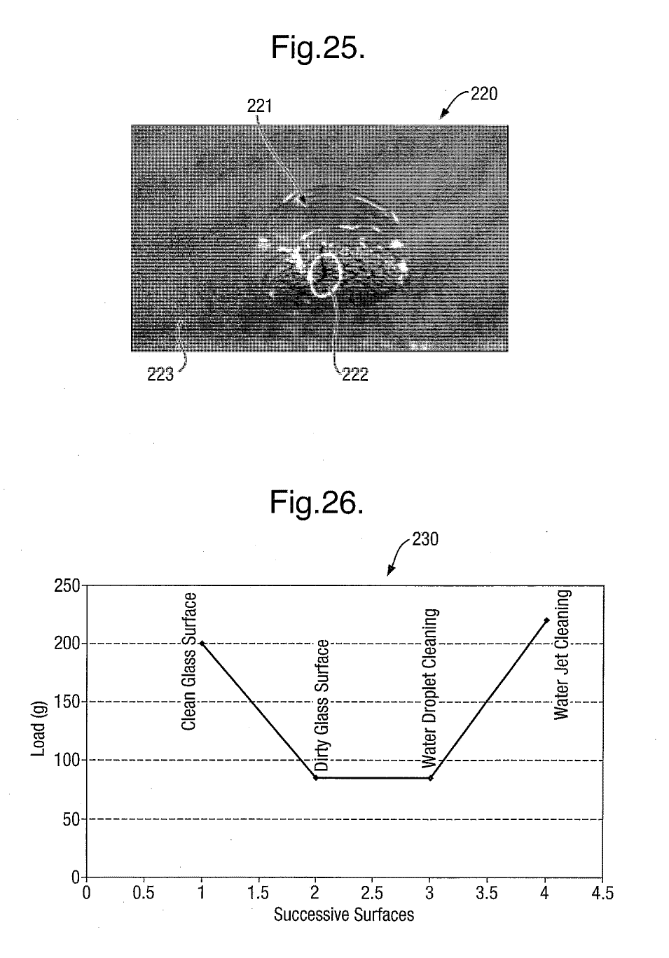

In order to exploit the superhydrophobic properties as a cleaning mechanism, a type 2 specimen was deliberately contaminated by dust and hair particles and measurements of adhesion made both in its pristine state, after contamination and after cleaning. In this instance, cleaning was obtained by both allowing water droplets to drop onto and roll off the surface without wetting in a manner akin to rain falling, and also using a jet of water ejected from a small squeezy bottle in which case some wetting of the surface occurred. Cleaning occurred in both cases. A “before” and “after” image for the droplet and water jet cleaning method for the specimen is shown in FIG. 24(a) to (c). A comparison between these images 215, 216, 217 shows that many hairs particles had been successfully removed from the surface using both processes. FIG. 25 is an image 220 which shows a small droplet 221 on the surface 223 in the process of cleaning, and where a hair 222 has become entrapped from the surface into the inside of a water droplet (as shown on the Figure).

Measurements of adhesion force recorded for the specimen were 200 g in its re-contamination state, 85 g when contaminated, 85 g after cleaning using droplets and 220 g after the water jet cleaning. These values are shown on a graph 230 schematically in FIG. 26. It is likely that in this instance, the water jet was sufficiently vigorous to remove those entrapped hairs which the water droplet method did not remove, and thereby permitted re-establishment of sufficient hair contact necessary for regaining the pre-contamination adhesion force.

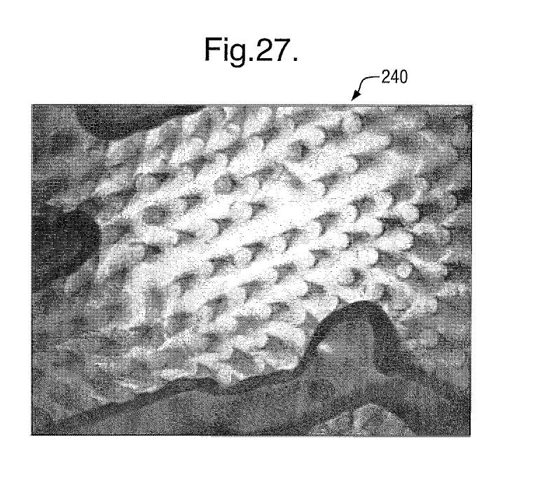

Skydrol is a common liquid used on aircraft and it was of interest to examine adhesion when the bond was contaminated by this liquid. An example of a type 2 specimen was tested by dropping fluid onto an already adhered specimen on a clean glass surface, and also by trying to establish adhesion on a Skydrol contaminated surface. Adhesion force dropped from 200 g to ˜40 g after 2 hours exposure to Skydrol on the pre-adhered clean glass surface, and was ˜10 g in adhesion testing on a pre-contaminated surface. FIG. 27 is an image 240 which shows that no appreciable contact was evident between the hair pads and the glass surface in the presence of the Skydrol. It was also noted that whilst the Skydrol resulted in poor adhesion to the glass contact surface, it also advantageously resulted in poor contact between hairs and removed clumping. Although it is not recommended that Skydrol should be used routinely for de-clumping, it was suggested the process of using such a liquid to reduce adhesion and remove clumps at the contact area between the adhesive material and the surface could at least be beneficial, provided that the liquid could then itself be removed from the material without deleterious effect.

Thus, having regard to the foregoing, it is recognised that the requirement for easy detachment of our adhesive material from the surface is an important consideration, for example for effective multiple attachment applications. Detachment could be achieved via a mechanical peeling action in some circumstances. However, it is equally recognised that certain circumstances may arise where a peeling action is not possible and it is still necessary to remove and then re-attach the material to a surface (at the same location or at a different location). It is proposed that under such circumstances it might be possible to weaken temporarily the bond at the contact area between the adhesive material and the surface, as seen in the de-clumping and reduced adhesion action of Skydrol. It is possible that Skydrol is not unique in conferring poor adhesion, and that there are other more environmentally-friendly liquids which could perform a similar function to Skydrol in respect of providing the de-clumping/reduced adhesion action. Given such liquids can be identified that rapidly penetrate between the hairs of the adhesive structure, rapidly evaporate after use and result in no deleterious effects, it is envisaged that such a scheme might be suitable for use as a multiple attachment methodology for large non-peelable adhesive materials.

Whilst we have described the use of particular polymer materials (as listed in Table 2 above) in the invention, the man skilled in the art will appreciate that other elastomers can be used in accordance with the present invention, with a reasonable amount of trial and experiment. Such other elastomers may be conventional elastomers or thermoplastic elastomers. They may be natural or synthetic. They may contain for example, styrene, butadiene, isoprene, chloropene, urethane, acrylonitrile, ethylene, propylene, ester, and/or amide units. If copolymers, they may be random or block copolymers.

A further envisaged application of the method of the present invention is in the production of adhesive microstructures based on a different combination of the above described methods. Cylindrical cavities are etched into a first silicon wafer extending through the thickness of the silicon based on steps A, B and D of method 1, omitting the step C (i.e. omit the bonding step to Pyrex/SD2 glass substrate). This wafer is then positioned and aligned on a second silicon wafer with cavities which is formed by method 2. PDMS is then introduced into the channels of the resultant mould structure in the same way as described in method 3 (see FIG. 4), and the new adhesive microstructure is then formed by effecting a pulling out step through the mould (as described in method 3—see steps 4. and 5. of FIG. 4).

It is to be understood that any feature described in relation to any one embodiment or Example may be used alone, or in combination with other features described, and may also be used in combination with one or more features of any other of the embodiments or Examples, or any combination of any other of the embodiments and Examples. Further, equivalents and modifications not described above may also be employed without departing from the scope of the invention, which is defined in the accompanying claims.

1. A fabricated adhesive microstructure comprising a deformable material which, in use, deforms to provide an adhesion strength at a substantially smooth glass surface of at least 120 kPa in air at one atmosphere pressure and at least 10 kPa less adhesion strength in vacuum than that at one atmosphere pressure.

2. An adhesive microstructure as claimed in claim 1, wherein the adhesion strength is in the range of between about 125 kPa and 220 kPa in air at one atmosphere pressure and in the range of between about 25 kPa and 120 kPa in vacuum.

3. An adhesive microstructure as claimed in claim 1, wherein the deformable material is an elastomer.

4. An adhesive microstructure as claimed in claim 3, wherein the elastomer is a silicone polymer.

5. An adhesive microstructure as claimed in claim 4, wherein the polymer material comprises polydimethylsiloxane (PDMS).

6. An adhesive microstructure as claimed in claim 5, wherein the PDMS is Sylgard 170, Sylgard 184 or Sylgard 186.

7. An adhesive microstructure as claimed in claim 3, wherein the elastomer is a polyurethane.

8. An adhesive microstructure as claimed in claim 7, wherein the polyurethane comprises monothane A30.

9. An adhesive microstructure as claimed in claim 1, wherein a first level of hierarchical compliance with the surface is provided in the structure by means of formation of a first number of protrusions on a first set of stalks, the protrusions and the stalks being formed of said deformable material and the protrusions being arranged to provide the adhesion strength at the surface.

10. An adhesive microstructure as claimed in claim 9, wherein the stalk lengths are in the range of between about 20 μm and 100 μm, and the protrusions have generally mushroom-shaped head formations with head diameters in the range of between about 10 μm and 40 μm and thicknesses in the range of between about 1 μm and 3 μm.

11. An adhesive microstructure as claimed in claim 9, wherein one or more additional levels of hierarchical compliance with the surface are provided in the structure by combination of said first set of stalks and said first number of protrusions with one or more additional sets of stalks and additional numbers of protrusions, the additional stalks and the additional protrusions being formed of said deformable material.

12. An adhesive microstructure as claimed in claim 1, wherein said deformable material is provided as a first layer on one surface of the structure and as a second layer on an opposing surface of the structure.

13. A fabricated adhesive microstructure comprising an elastomer which, in use, deforms to provide an adhesion strength at a substantially smooth glass surface of at least 120 kPa in air at one atmosphere pressure and at least 10 kPa less adhesion strength in vacuum than that at one atmosphere pressure.

14. An adhesive microstructure as claimed in claim 13, wherein the adhesion strength is in the range of between about 125 kPa and 220 kPa in air at one atmosphere pressure and in the range of between about 25 kPa and 120 kPa in vacuum.

15. An adhesive microstructure as claimed in claim 13, wherein the elastomer is a silicone polymer.

16. An adhesive microstructure as claimed in claim 15, wherein the polymer material comprises polydimethylsiloxane (PDMS).

17. An adhesive microstructure as claimed in claim 16, wherein the PDMS is Sylgard 170, Sylgard 184 or Sylgard 186.

18. An adhesive microstructure as claimed in claim 13, wherein the elastomer is a polyurethane.

19. An adhesive microstructure as claimed in claim 18, wherein the polyurethane comprises monothane A30.

20. An adhesive microstructure as claimed in claim 13, wherein a first level of hierarchical compliance with the surface is provided in the structure by means of formation of a first number of protrusions on a first set of stalks, the protrusions and the stalks being formed of said elastomer and the protrusions being arranged to provide the adhesion strength at the surface.

21. An adhesive microstructure as claimed in claim 20, wherein the stalk lengths are in the range of between about 20 μm and 100 μm, and the protrusions have generally mushroom-shaped head formations with head diameters in the range of between about 10 μm and 40 μm and thicknesses in the range of between about 1 μm and 3 μm.

22. An adhesive microstructure as claimed in claim 20, wherein one or more additional levels of hierarchical compliance with the surface are provided in the structure by combination of said first set of stalks and said first number of protrusions with one or more additional sets of stalks and additional numbers of protrusions, the additional stalks and the additional protrusions being formed of said elastomer.

23. An adhesive microstructure as claimed in claim 13, wherein said elastomer is provided as a first layer on one surface of the structure and as a second layer on an opposing surface of the structure.

24. A method of fabricating an adhesive microstructure comprising the steps of—
(i) providing a mould structure;
(ii) introducing a curable liquid polymer into the mould structure;
(iii) curing the polymer in the structure; and thereafter
(iv) separating the polymer from the mould structure to form the microstructure.

25. A method as claimed in claim 24, wherein the mould structure is provided by forming first and second arrays of cavities at opposing surfaces of a base material, and forming an array of channels which extend through the base material at predetermined regions between said first and second arrays of cavities.

26. A method as claimed in claim 25, wherein the cavities of said first array have a significantly different size from the cavities of said second array.

27. A method as claimed in claim 26, wherein the cavities of said first array have diameters of approximately 40 μm and the cavities of said second array have diameters of approximately 20 μm.

28. A method as claimed in claim 27, which includes a step of providing a support made of pyrex, and bonding said support to the surface of the base material at which the 40 μm diameter cavities are formed.

29. A method as claimed of claim 25, wherein the base material is formed of silicon.

30. A method as claimed in claim 24, wherein the mould structure is provided by forming an array of channels through a base material which is supported on an etch-stop backing material.

31. A method as claimed in claim 30, wherein the base material is formed of silicon and the etch-stop backing material is formed of silicon oxide.

32. A method as claimed in claim 24, wherein the mould structure is provided by the following steps:
(a) forming a first array of cavities at a surface of a first base material;
(b) forming an array of channels through a second base material which is supported on an etch-stop backing material;
(c) attaching the first base material to the second base material at a surface such as to provide an alignment between the cavities in the first base material and the channels in the second base material at said surface; and
(d) forming a second array of cavities at an exterior exposed surface of the attached base material, and forming an array of channels therefrom which extend through the base material at predetermined regions between said second array of cavities and said surface at which the cavities in the first base material and the channels in the second base material are aligned.

33. A method as claimed in claim 32, wherein the first base material is attached to the second base material using a bonding process.

34. A method as claimed in claim 32, wherein the first base material is attached to the second base material by clipping the first and second base materials together.

35. A method as claimed in claim 32, wherein the first and second base materials are formed of silicon, and the etch-stop backing material is formed of silicon oxide.

36. A method as claimed in claim 32, wherein the cavities of said first array have a significantly different size from the cavities of said second array.

37. A method as claimed in claim 36, wherein the cavities of said first array have diameters of approximately 40 μm and the cavities of said second array have diameters in the range of between about 7 μm and 20 μm.

38. A method as claimed in claim 25, wherein each said array of cavities and each said array of channels are formed by applying lithography and etching techniques through the use of masks.

39. A method as claimed in claim 24, wherein the curing step comprises applying heat to the polymer in said structure at elevated temperature for a predetermined duration.

40. A method as claimed in claim 39, wherein the elevated temperature is approximately 65° C. and the predetermined duration is approximately 4 hours.

41. A method as claimed in claim 24, wherein the liquid polymer cures to an elastomer.

42. A method as claimed in claim 24, wherein the liquid polymer comprises polydimethylsiloxane (PDMS).

43. A method as claimed in claim 42, wherein the PDMS is Sylgard 170, Sylgard 184 or Sylgard 186.

44. A method as claimed in claim 24, wherein the liquid polymer comprises monothane A30.

45. A method as claimed in claim 25, wherein the liquid polymer is introduced into the mould structure by—
(a) distributing the polymer across the channels of the structure;
(b) placing the structure inside a chamber in vacuum and controllably extracting air from the channels;
(c) restoring the chamber to atmospheric pressure; and thereafter
(d) infiltrating the polymer into the channels.

46. A method of fabricating a double-sided adhesive microstructure comprising the steps of—
(i) forming a first adhesive microstructure according to the method as claimed in claim 24;
(ii) partially forming a second adhesive microstructure according to steps (i) and
(ii) of the method as claimed in claim 24;
(iii) pressing the formed first microstructure onto the partially formed second microstructure whilst the polymer, PDMS for example, in the mould structure is in liquid condition;
(iv) curing the pressed structure of (iii); and thereafter
(v) separating the cured structure of (iv) from the mould structure so as to form the double-sided microstructure.

47. A method as claimed in claim 46, wherein the curing step comprises applying heat to the pressed structure at elevated temperature for a predetermined duration.

48. A method as claimed in claim 47, wherein heat is applied to the pressed structure inside an oven at approximately 150° C. for approximately 10 minutes.

49. A method of fabricating a double-sided adhesive microstructure comprising the steps of—
(i) defining a structure with a cavity region by juxtaposing first and second mould structures;
(ii) introducing liquid polymer into the cavity region and subjecting the defined structure of (i) to vacuum conditions thereby to cause filling of the cavity region by said polymer;
(iii) curing the filled structure of (ii); and
(iv) removing the first and second mould structures to leave a formation of the double-sided microstructure.

50. A method as claimed in claim 49, wherein the first and second mould structures are in juxtaposed spatial alignment by providing a nylon spacer between said mould structures.

51. A method as claimed in claim 49, wherein the first and second mould structures are removed in aforesaid step (iv) by mechanical release.

52. A method is claimed in claim 49, wherein the first and second mould structures are removed in aforesaid step (iv) using a chemical etching process.

53. A method as claimed in claim 49, wherein the aforesaid curing step (iii) comprises applying heat to the filled structure at elevated temperature for a predetermined duration.

54. A method as claimed in claim 53, wherein heat is applied to the filled structure inside an oven at approximately 150° C. for approximately 10 minutes.

55. A method as claimed in claim 49, wherein the first and second mould structures are formed of silicon.

56. A method as claimed in claim 49, wherein the first and second mould structures are formed of polyimide.

57. A method as claimed in claim 49, wherein the polymer comprises PDMS (Sylgard 184).

58. A method of removably attaching a fabricated adhesive microstructure to a surface comprising the steps of:
(i) applying the microstructure as claimed in claim 1 to the surface at a first location; and
(ii) removing the microstructure for re-application to the surface at the same location or at a different location.

59. A method as claimed in claim 58, wherein the aforesaid removing step (ii) comprises a peeling action.

60. A method as claimed in claim 58, wherein the aforesaid removing step (ii) is effected or assisted by application of a chemical agent at the contact location between said surface and said microstructure.

61. A method as claimed in claim 60, wherein the chemical agent comprises Skydrol liquid.

62. (canceled)

63. (canceled)
